(19) United States
(12) Patent Application Publication
(10) Pub. No.: US 2014/0104615 A1
(43) Pub. Date: Apr. 17, 2014

(54) DEVICE FOR DETECTING FLUCTUATION IN MOISTURE CONTENT, METHOD FOR DETECTING FLUCTUATION IN MOISTURE CONTENT, VACUUM GAUGE, AND METHOD FOR DETECTING FLUCTUATION IN VACUUM DEGREE

(71) Applicant: Panasonic Corporation, Osaka (JP)

(72) Inventors: Yuriko KANEKO, Nara (JP); Takuya IWAMOTO, Osaka (JP); Ushio SANGAWA, Nara (JP); Takahiro KAMAI, Kyoto (JP); Masahiko HASHIMOTO, Osaka (JP)

(73) Assignee: Panasonic Corporation, Osaka (JP)

(21) Appl. No.: 14/107,260

(22) Filed: Dec. 16, 2013

Related U.S. Application Data
(63) Continuation of application No. PCT/JP2013/002370, filed on Apr. 5, 2013.

(30) Foreign Application Priority Data
Apr. 19, 2012 (JP) 2012-095996
Apr. 19, 2012 (JP) 2012-096018

(51) Int. Cl. G01N 21/17; G01N 21/59

(52) U.S. Cl. CPC G01N 21/1702; G01N 21/59
USPC 356/432

(57) ABSTRACT

A moisture content fluctuation detection device including: a silica aerogel placed, disposed to a measurement object space; and a detection unit configured to detect fluctuation in moisture content within the measurement object space, the detection unit including: a light source configured to emit light to the silica aerogel, the light having at least a portion of a range of wavelengths of 1850 nm or greater and 1970 nm or less; a light receiving unit configured to receive the light which has passed through the silica aerogel and has at least a portion of the range of wavelengths of 1850 nm or greater and 1970 nm or less; and a calculation unit configured to calculate the fluctuation in moisture content within the measurement object space from change in light intensity of the light received by the light receiving unit.

### CROSS REFERENCE TO RELATED APPLICATIONS

This is a continuation application of PCT International Application No. PCT/JP2013/002370 filed on Apr. 5, 2013, designating the United States of America, which is based on and claims priority of Japanese Patent Application No. 2012-095996 filed on Apr. 19, 2012 and Japanese Patent Application No. 2012-096018 filed on Apr. 19, 2012. The entire disclosures of the above-identified applications, including the specifications, drawings and claims are incorporated herein by reference in their entirety.

### FIELD

One or more exemplary embodiments disclosed herein relate generally to a moisture content fluctuation detection device and a moisture content fluctuation detection method which detect moisture content fluctuation in the space, and a vacuum gauge and a vacuum degree fluctuation detection method which detect fluctuations in vacuum degree within a process chamber, based on the moisture content fluctuation in the space.

### BACKGROUND

Copious amount of moisture is present in the atmosphere and thus moisture is highly likely to penetrate to fabrication processing. Since moisture is a polar molecule, adsorption of moisture to a metal surface or the like is also likely to occur. For these reasons, moisture is one of residual contaminants which are significantly problematic in various fabrication processes.

In recent vacuum-assisted processes, to produce higher quality industrial goods, a process chamber is once evacuated to a high vacuum region at about 10⁻⁴ Pa for cleaning, and a gas is then introduced into the process chamber to perform processing such as sputtering.

Here, in a process in which the moisture content in a gas varies from moment to moment, such as a process of evacuating the atmosphere to vacuum and providing gas purge by removing the atmosphere for evacuation, feedback to the process is delayed unless the fluctuation in moisture content is continuously and directly monitored. Moreover, the pressure (vacuum degree) within the chamber significantly varies ranging from the atmospheric pressure to high vacuum. Thus, a vacuum gauge covering a wide measurement range is of high importance.

In a process of evacuating to the high vacuum region, pumping arrangement used may be changed over from one to another depending on ultimate vacuum, such that a rotary pump is used at the atmospheric pressure to 10⁻¹ Pa, and a turbomolecular pump is used at 10⁻¹ Pa to 10⁻⁴ Pa. The changeover process of the pumping arrangement occurs mainly before and after 10⁻¹ Pa, and thus it is preferable that vacuum degrees, in particular, before and after 10⁻¹ Pa are continuously monitored so that feedback can be provided once a trouble happens.

Methods of measuring moisture (vapor) concentration in a gas conventionally include a quartz-crystal balance method in which change in frequency of a crystal oscillator to which a sensitive membrane which adsorbs moisture is adhered, is measured, a capacitive method in which variations in capacitance of the sensitive membrane is measured, and a method in which cobalt chloride is added to a silica gel and the adsorption of moisture content to the silica gel is detected from variations in color of the cobalt chloride.

Furthermore, in recent years, a moisture concentration measuring equipment is proposed which measures the moisture concentration in a gas by an infrared absorption spectroscopy utilizing absorption of a laser beam in an infrared region (for example, see Patent Literature (PTL) 1). According to PTL 1, the moisture concentration measuring equipment measures moisture concentration in a state where the laser beam is frequency-modulated. By calculating the moisture concentration based on a second-order harmonic synchronous detection signal, which is obtained by synchronously detecting a transmitted light detection signal, the effect of interfering moisture within an optical chamber can be ignored and the moisture concentration of a measurement object gas in a measurement object sample cell is obtained.

Conventionally, a Pirani gauge and an ionization gauge are used as devices which measure the vacuum degree. The vacuum degree is measured by a Pirani gauge in a low vacuum region ranging from 10³ Pa to 10⁻¹ Pa, and measured by the ionization gauge in a high vacuum region ranging from 10⁻¹ Pa to 10⁻⁵ Pa. Thus, it is common that measuring equipment is changed over from one to another.

There have also been proposals for achieving a vacuum gauge that has a wider pressure measurement range without changeover of measurement equipment (for example, see PTL 2). In PTL 2, the ionization gauge includes, to enable the measurement in the low vacuum region, a heating arrangement for heating a collector and diverts a collector electrode as a pressure measurement element of a Pirani gauge, thereby allowing for wide bandwidth pressure measurement in a range from the atmospheric pressure up to 10⁻⁹ Pa by one gauge head.

An alternative for measuring the vacuum degree is to measure the vacuum degree by measuring the density of water molecules within a process chamber (for example, see NPTL 1). Examples of the method of measuring the density of water molecule include, similarly to the above-mentioned method of measuring the moisture concentration, a method in which cobalt chloride is added to a silica gel and the adsorption of moisture content to the silica gel is detected from variations in color of the cobalt chloride.

### CITATION LIST

### Patent Literature

[PTL 1] Japanese Unexamined Patent Application Publication No. 2011-117868
[PTL 2] International Publication WO2006121173

### Non-Patent Literature

[NPTL 1] Chokoshinku (Ultrahigh Vacuum), Chikara HAYASHI, Souji KOMIYA, P. 105, Nikkan Kogyo Shimbun, October, 1964

### SUMMARY

### Technical Problem

The moisture concentration measuring equipment using the conventional infrared absorption spectroscopy, however, needs to change the frequency modulation of a laser beam when the moisture concentration in the measurement object space varies, and thus continuous measurement cannot be performed. Moreover, the moisture concentration measuring equipment using the conventional infrared absorption spectroscopy has a problem that when the concentration of moisture content in the measurement object space rapidly varies due to a certain unexpected incident, the frequency modulation of the laser beam does not change in time to conduct continuous monitoring.

For vacuum gauges, the configurations of a conventional Pirani gauge and a conventional ionization gauge allow for the measurement of wide bandwidth pressures, using one gauge head, in the range from the atmospheric pressure up to 10⁻⁹ Pa. However, due to differences in measurement principle, changeover operation occurs, and continuous measurement of wide bandwidth pressures is difficult. In addition, there is a problem of bad responsibility with a method which uses silica gel to measure the density of water molecule as a representation of gaseous molecules.

One non-limiting and exemplary embodiment provides a moisture content fluctuation detection device, a moisture content fluctuation detection method, a vacuum gauge, and a vacuum degree fluctuation detection method, which can continuously measure fluctuations in moisture content or fluctuations in wide bandwidth pressure without changeover operation even if the moisture content or pressure in the measurement object space significantly changes.

### Solution to Problem

In one general aspect, the techniques disclosed here feature a moisture content fluctuation detection device including: a silica aerogel placed, exposed to a measurement object space; and a detection unit configured to detect fluctuation in moisture content within the measurement object space, the detection unit including: a light source for emitting light to the silica aerogel, the light having at least a portion of a range of wavelengths of 1850 nm or greater and 1970 nm or less; a light receiving unit configured to receive light that has passed through the silica aerogel and has at least a portion of the range of wavelengths of 1850 nm or greater and 1970 nm or less; and a calculation unit configured to calculate the fluctuation in moisture content within the measurement object space, based on light intensity of the light received by the light receiving unit.

Moreover, in one general aspect, the techniques disclosed here feature a moisture content fluctuation detection method including: emitting, by a light source, light to a silica aerogel placed, exposed to a measurement object space, the light having at least a portion of a range of wavelengths of 1850 nm or greater and 1970 nm or less; receiving, by a light receiving unit, light that has passed through the silica aerogel and has at least a portion of the range of wavelengths of 1850 nm or greater and 1970 nm or less; and calculating, by a calculation unit, fluctuation in moisture within the measurement object space, based on light intensity of the light received by the light receiving unit.

Moreover, in one general aspect, the techniques disclosed here feature a vacuum gauge including: a silica aerogel placed, exposed to a measurement object space; and a detection unit configured to detect pressure fluctuation within the measurement object space, the detection unit including: a light source for emitting light to the silica aerogel, the light having at least a portion of a range of wavelengths of 1850 nm or greater and 1970 nm or less; a light receiving unit configured to receive light that has passed through the silica aerogel and has at least a portion of the range of wavelengths of 1850 nm or greater and 1970 nm or less; a thermometer for measuring a temperature within the measurement object space; and a calculation unit configured to calculate the pressure fluctuation within the measurement object space, based on light intensity of the light received by the light receiving unit and the temperature measured by the thermometer.

Moreover, in one general aspect, the techniques disclosed here feature a vacuum degree fluctuation detection method including: emitting, by a light source, light to a silica aerogel placed, exposed to a measurement object space, the light having at least a portion of a range of wavelengths of 1850 nm or greater and 1970 nm or less; receiving, by a light receiving unit, light that has passed through the silica aerogel and has at least a portion of the range of wavelengths of 1850 nm or greater and 1970 nm or less; measuring, by a thermometer, a temperature within the measurement object space; and calculating, by a calculation unit, pressure fluctuation within the measurement object space, based on light intensity of the light received by the light receiving unit and the temperature measured by the thermometer.

Additional benefits and advantages of the disclosed embodiments will be apparent from the Specification and Drawings. The benefits and/or advantages may be individually obtained by the various embodiments and features of the Specification and Drawings, which need not all be provided in order to obtain one or more of such benefits and/or advantages.

### Advantageous Effects

According to one or more exemplary embodiments or features disclosed herein, the moisture content fluctuation detection device, the moisture content fluctuation detection method, the vacuum gauge, and the vacuum degree fluctuation detection method can be provided which can continuously detect fluctuations in moisture content or fluctuations in wide bandwidth pressure without changeover operation even if the moisture content or pressure in the measurement object space significantly changes.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a schematic view showing an example of a moisture content fluctuation detection device according to Embodiment 1.

FIG. 2A is a block diagram of an example configuration of a calculation unit according to Embodiment 1.

FIG. 2B is a diagram showing an example of a table including values of change in light intensity and values of fluctuation in moisture content according to Embodiment 1.

FIG. 3 is a schematic diagram showing the structure of a silica aerogel according to Embodiment 1.

FIG. 4 is a schematic view of the measurement system for the transmission spectrum of the silica aerogel according to Embodiment 1.

FIG. 5 is a diagram showing an example of the transmission spectrum of the silica aerogel.

FIG. 6 is a schematic view of a configuration for detecting fluctuation in moisture content in a process chamber according to Embodiment 1.

FIG. 7 is a diagram showing a result of detecting the fluctuation in moisture content during a process of exposing the process chamber in a nitrogen atmosphere to the atmosphere by the moisture content fluctuation detection device according to the present embodiment.

FIG. 8 is a diagram showing a result of detecting the fluctuation in moisture content during a process of the moisture content fluctuation detection device according to the present embodiment exposing the process chamber under high vacuum to the atmosphere.

FIG. 9 is a diagram showing the transmittance of the silica aerogel at a plurality of light wavelengths relative to days of storage of the silica aerogel.

FIG. 10 is a diagram showing the transmittance of the silica aerogel at a light wavelength of 1900 nm relative to the time course of the silica aerogel.

FIG. 11 is a schematic view of the configuration of a moisture content fluctuation detection device according to a variation 1 of Embodiment 1.

FIG. 12 is a schematic view of the configuration of a moisture content fluctuation detection device according to a variation 2 of Embodiment 1.

FIG. 13 is a schematic view of the configuration of a moisture content fluctuation detection device according to a variation 3 of Embodiment 1.

FIG. 14A, is a schematic view of the configuration of a moisture content fluctuation detection device according to a variation 4 of Embodiment 1.

FIG. 14B is a diagram showing an example of a table including values of change in light intensity and values of the moisture content according to Embodiment 3.

FIG. 15 is a schematic view showing an example of a vacuum gauge according to Embodiment 4.

FIG. 16 is a diagram showing relative pressure fluctuation per second where 100% represents the atmospheric pressure.

FIG. 17 is a schematic view of the configuration of a vacuum gauge according to a variation 1 of Embodiment 4.

FIG. 18 is a schematic view of the configuration of a vacuum gauge according to a variation 2 of Embodiment 4.

FIG. 19 is a schematic view of the configuration of a vacuum gauge according to a variation 3 of Embodiment 4.

FIG. 20 is a schematic diagram showing a surface profile of a silica gel according to a conventional technology.

FIG. 21 is a flowchart illustrating measurement operation of a moisture content fluctuation detection device according to the conventional technology.

FIG. 22 is a diagram showing a result of a conventional method detecting pressure fluctuations within a chamber in the atmospheric pressure evacuated to 10⁻⁴ Pa.

FIG. 23 is a diagram showing partial pressures of residual gases in various vapor deposition apparatuses according to the conventional technology.

### DESCRIPTION OF EMBODIMENTS

### Underlying Knowledge Forming Basis of the Present Disclosure

First, underlying knowledge forming the basis of the present disclosure will be described with reference to the accompanying drawings.

Conventionally, there are known methods of measuring moisture (vapor) concentration, i.e., the density of water molecule in a gas, including a quartz-crystal balance method in which change in frequency of a crystal oscillator to which a sensitive membrane which adsorbs moisture is adhered, is measured, a capacitive method in which variations in capacitance of the sensitive membrane is measured. Such methods, however, are poorly suited for measuring trace moisture.

Examples of a conventional vacuum gauge include a Pirani gauge and an ionization gauge as described above.

A Pirani gauge includes a hot filament made of a metallic wire, stretched in a vacuum, and the hot filament is heated. When a gaseous molecule at a lower temperature than the hot filament collide with the hot filament at an elevated temperature, the gaseous molecule collided with the hot filament removes heat from the hot filament. This changes the temperature of the hot filament. The Pirani gauge converts a temperature change corresponding to the removed heat into a pressure value to measure the pressure of gas. The measurement ranges from about 10³ Pa to about 10⁻¹ Pa.

The ionization gauge ionizes a gas and measures a current flowing through a filament to obtain the pressure of gas. The ionization gauge includes a filament from which electrons are emitted, a grid, and a collector which collects ions. Electrons emitted from the filament are accelerated toward the grid through several number of reciprocation within a chamber, ionizing the gas during the course. The ionized gas is accelerated toward the collector producing an ion current that is measured, thereby indirectly measuring the pressure of gas. The measurement range is from about 10⁻¹ Pa to about 10⁻⁵ Pa.

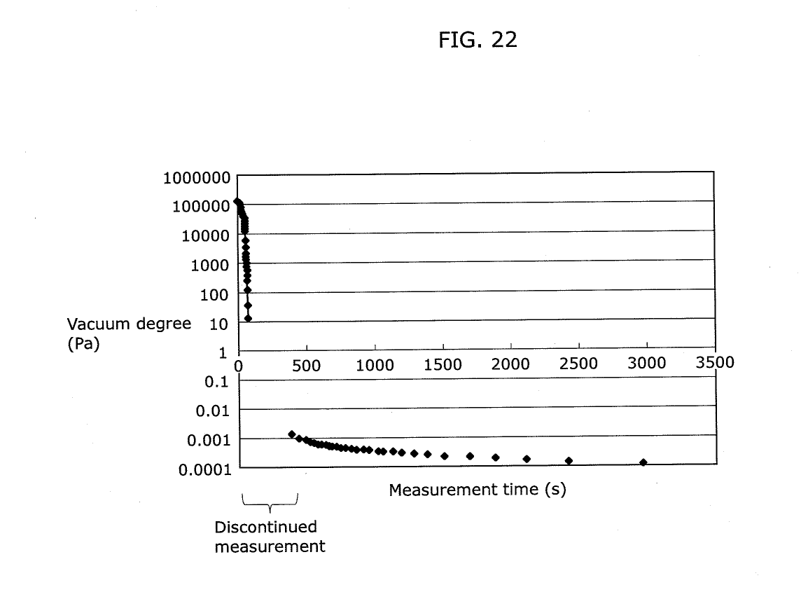

It is common for the measurement of vacuum degree that measuring equipment is changed over from one to another such that the Pirani gauge is used in low vacuum regions at 10³ Pa to 10⁻¹ Pa, and the ionization gauge is used in the high vacuum region at 10⁻¹ Pa to 10⁻⁵ Pa. FIG. 22 is a diagram showing a result of a conventional method detecting pressure fluctuations within a chamber in the atmospheric pressure evacuated to 10⁻⁴ Pa. For example, as shown in FIG. 22, a result of measurement using a conventional Pirani gauge and a conventional ionization gauge includes a time period where no measurement data is obtained.

To achieve a vacuum gauge that has a wider pressure measurement range (for example, see PTL 1), the ionization gauge includes a heating arrangement for heating a collector and diverts a collector electrode as a pressure measurement element of a Pirani gauge, thereby allowing for wide bandwidth pressure measurement in a range from the atmospheric pressure up to 10⁻⁹ Pa by one gauge head.

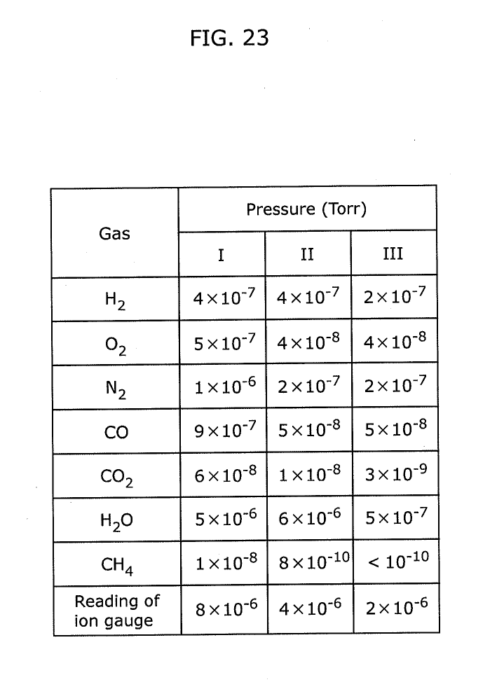

An alternative for measuring the vacuum degree is to measure the vacuum degree by measuring the density of water molecules as a representation of gases within the process chamber. FIG. 23 is a diagram showing partial pressures of residual gases in various vapor deposition apparatuses according to the conventional technology. For example, NPTL 1 mentioned above discloses partial pressures of residual gas in various vapor deposition apparatuses which are shown in FIG. 23.

In FIG. 23, I is a vapor deposition apparatus for use on a daily basis for deposition of Sn, Pb, and SiO, II is a vapor deposition apparatus for use on a daily basis for deposition of a magnetic thin film, III is a vapor deposition apparatus for deposition of a magnetic thin film as with II that uses no Ti getter with minor trap. It can be seen that a difference in vapor deposition apparatus used or in how it is used results different partial pressures of residual gases, despite of the same vacuum degree of 10⁻⁴ Pa (10⁻⁶ Torr). It can be also seen that among multiple residual gases, water molecules have relatively high partial pressure. In other words, by detecting the variation in density of water molecules that remain even under a vacuum, conversion of the density of water molecules into pressure fluctuations is theoretically possible. To obtain the vacuum degree in addition to the detection of the variations in density of water molecules, the same process chamber and the same conditions of use (such as gas, jig) as those used for the measurement may be used and calibrated using a vacuum gauge.

Examples of the method of detecting the variations in density of water molecule include a method in which cobalt chloride is added to a silica gel and the adsorption of moisture content to the silica gel is detected from variations in color of the cobalt chloride. The silica gel comprises porous silica particles, and the density is 2200 kg/m³.

FIG. 20 is a schematic diagram showing a surface profile of a silica gel. As shown in FIG. 20, a silica gel 1000 has pores 1001 on the face. The pore 1001 includes circumferential side and bottom faces (hereinafter, these faces will be referred to as a pore wall), the pore (hereinafter, referred to as a closed pore) manly has an open plane in one direction.

Hydrogen desorption characteristics of the silica gel 1000 is significantly affected by the pore size of the silica gel 1000. The silica gel 1000, in general, includes A-type and B-type. A silica gel A-type has a small pore size of about 2.4 nm and thus an interaction potential in which the pore wall affects adsorbed moisture is great. Moisture once adsorbed onto the closed pore 1001 does not desorb without being heated. This is the reason why the silica gel A-type is used as desiccant. The silica gel B-type, on the other hand, has a pore size of about 6 nm which is larger than the silica gel A-type, and thus desorbs moisture at room temperature. Therefore, the silica gel B-type is used as humidity controlling desiccant. While an interaction potential in which the pore wall affects adsorbed moisture in the silica gel B-type is less than the silica gel A-type, its effect remains great. Thus, the silica gel B-type has a slow response time required for desorbing moisture, and it is difficult to keep up with fluctuations in moisture content in the measuring space. In general, it is believed that adsorption of moisture to the closed pore 1001 having a pore size of 2 nm to 10 nm is physical adsorption which involves a phase transition from gas to liquid and requires energy reasonable for desorption.

A porous body which as a larger pore size than the silica gel 1000, in general, has a smaller specific surface area and less adsorbing capacity as the pore size increases, and thus is not a suitable method for monitoring the variations in density of water molecule.

In contrast to these methods, recently, a moisture concentration measuring equipment is proposed which measures moisture concentration in a gas by an infrared absorption spectroscopy utilizing absorption of a laser beam in an infrared region. The moisture concentration measuring equipment emits a laser beam having a predetermined wavelength to a sample cell in which a measurement object gas is introduced, analyzes a laser beam passed through the sample cell, and derives moisture concentration from a degree of infrared absorption by moisture in the gas.

Such a moisture concentration measurement method using a laser beam has the following problem. Specifically, the laser beam not only passes through the measurement object gas but also partially passes through a space other than the gas. Thus, moisture from the atmosphere in the space (hereinafter, referred to as “interfering moisture”) as a background noise can affect a measurement result. To eliminate the effect, in general, a method is employed in which a purge gas is provided into a chamber which houses optical components, such as a laser beam source and photodetector, to reduce the amount of interfering moisture.

Copious amount of interfering moisture, however, is present in the atmosphere. Thus, it is necessary, even with use of the above method, to keep track of the interfering moisture conditions to ensure that all the interfering moisture is removed.

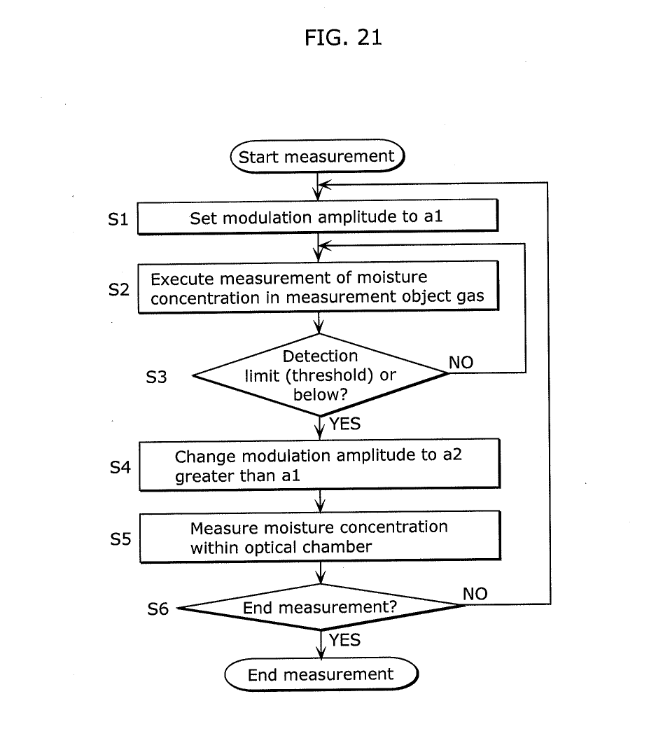

Thus, a moisture concentration measuring equipment is proposed which can keep track of the interfering moisture content and prevent the measurement system from falling into an anomalous state (for example, see PTL 1). FIG. 21 is a flowchart illustrating the measurement operation of moisture measurement equipment disclosed in PTL 1. According to PTL 1, the moisture concentration measuring equipment measures moisture concentration in a state where the laser beam is frequency-modulated. By calculating the moisture concentration based on a second-order harmonic synchronous detection signal, which is obtained by synchronously detecting a transmitted light detection signal, the effect of interfering moisture within an optical chamber can be ignored and the moisture concentration of a measurement object gas in a sample cell is obtained. When the interior of the sample cell is at high vacuum environment (10⁻¹ Torr), reaching detection limit or below, modulation amplitude is switched to enhance the detection sensitivity for the interfering moisture. This calculates concentration of the interfering moisture, based on the second-order harmonic synchronous detection signal.

The moisture concentration measuring equipment using the conventional infrared absorption spectroscopy, however, needs to change the frequency modulation of a laser beam when the pressure or the moisture concentration in the measurement object space varies, and thus continuous measurement cannot be performed. Moreover, the moisture concentration measuring equipment using the conventional infrared absorption spectroscopy has a problem that when the pressure or the concentration of the moisture content in the measurement object space rapidly varies due to a certain unexpected incident, the frequency modulation of the laser beam does not change in time to conduct continuous monitoring.

For vacuum gauges, the configurations of the above-described Pirani gauge and ionization gauge allow for the measurement of wide bandwidth pressures, using one gauge head, in the range from the atmospheric pressure up to 10⁻⁹ Pa. However, due to differences in measurement principle, changeover operation occurs, and continuous monitoring of the vacuum degree is difficult. In addition, there is a problem of bad responsibility with a method which uses the silica gel 1000 to measure the density of water molecule as a representation of gaseous molecules.

Thus, the inventors found a moisture content fluctuation detection device, a moisture content fluctuation detection method, a vacuum gauge, and a vacuum degree fluctuation detection method, which can continuously detect fluctuations in moisture content or fluctuations in wide bandwidth pressure without changeover operation even if the moisture content or pressure in the measurement object space significantly changes.

Specifically, a moisture content fluctuation detection device according to one aspect disclosed herein is a moisture content fluctuation detection device including: a silica aerogel placed, exposed to a measurement object space; and a detection unit configured to detect fluctuation in moisture content within the measurement object space, the detection unit including: a light source for emitting light to the silica aerogel, the light having at least a portion of a range of wavelengths of 1850 nm or greater and 1970 nm or less; a light receiving unit configured to receive light that has passed through the silica aerogel and has at least a portion of the range of wavelengths of 1850 nm or greater and 1970 nm or less; and a calculation unit configured to calculate the fluctuation in moisture content within the measurement object space, based on light intensity of the light received by the light receiving unit.

According to the above configuration, even if the moisture concentration in the measurement object space significantly changes, the fluctuation in moisture content can be continuously monitored in a responsive manner, without changeover operation. Thus, feedback for process control can be quickly provided by detecting a rapid fluctuation in moisture content during the process.

Moreover, the silica aerogel may have: through holes mainly having pore sizes of 10 nm or greater; a specific surface area of 400 m²/g or greater and 800 m²/g or less; and a density of 50 kg/m³ or greater and 500 kg/m³ or less.

According to the above configuration, since the silica aerogel includes the through holes that have sizes 10-fold or greater as compared to closed pores of a silica gel, the specific surface area is larger as well. Thus, the fluctuation in moisture content can be efficiently detected.

Moreover, the detection unit may further include a light intensity storage unit configured to store light intensity of received light, and the calculation unit may refer to a relationship between change in light intensity and fluctuation in moisture content in association and calculate fluctuation in moisture content, based on a difference between the light intensity of the light received by the light receiving unit and the light intensity stored in the light intensity storage unit.

Moreover, the calculation unit may refer to the light intensity of the light received by the light receiving unit and the relationship between the change in light intensity and the fluctuation in moisture content in association and calculate moisture content per unit volume.

According to the above configuration, the fluctuation in moisture content can be precisely detected. Moreover, the moisture content can be quantitatively measured.

Moreover, the light emitted by the light source may further have at least a portion of a range of wavelengths of 600 nm or greater and less than 1850 nm or a portion of a range of wavelengths of 1970 nm or greater and 2000 nm or less, the light receiving unit may further receive light having at least a portion of the range of wavelengths of 600 nm or greater and less than 1850 nm or a portion of the range of wavelengths of 1970 nm or greater and 2000 nm or less, and the light receiving unit may detect the fluctuation in moisture content within the measurement object space from change in ratio between the light intensity of the light that is received by the light receiving unit and has at least a portion of the range of wavelengths of 600 nm or greater and less than 1850 nm or a portion of the range of wavelengths of 1970 nm or greater and 2000 nm or less and light intensity of the light having at least a portion of the range of wavelengths of 1850 nm or greater and 1970 nm or less.

According to the above configuration, the fluctuation in moisture content can be precisely detected, without the effect, if any, of variation in transmittance of the silica aerogel during measurement.

Moreover, the measurement object space may be a space within a variable pressure chamber, the chamber may include one or more measurement windows through which light is allowed to transmit, the light having at least a portion of the range of wavelengths of 1850 nm or greater and 1970 nm or less, the light emitted by the light source disposed outside the chamber may be emitted through the one or more measurement windows to the silica aerogel placed within the chamber, and the light emitted to the silica aerogel that has passed through the silica aerogel may be received through the one or more measurement windows by the light receiving unit disposed outside the chamber.

According to the above configuration, the configuration inside the chamber can be minimized. Thus, the fluctuation in moisture content can be precisely detected.

Moreover, the measurement object space may be a space within a variable pressure chamber, the chamber may include one or more measurement windows through which light having at least a portion of the range of wavelengths of 1850 nm or greater and 1970 nm or less and light having at least a portion of the range of wavelengths of 600 nm or greater and less than 1850 nm or a portion of the range of wavelengths of 1970 nm or greater and 2000 nm or less are allowed to pass, the light emitted by the light source disposed outside the chamber may be emitted through the one or more measurement windows to the silica aerogel placed within the chamber, and the light emitted to the silica aerogel that has passed through the silica aerogel may be received through the one or more measurement windows by the light receiving unit disposed outside the chamber.

Moreover, the measurement object space may be a space within a variable pressure chamber, the light source and the light receiving unit may be disposed outside the chamber, the light emitted by the light source may be emitted via an emitting optical fiber to the silica aerogel placed within the chamber, and the light emitted to the silica aerogel that has passed through the silica aerogel may be received via a receiving optical fiber by the light receiving unit disposed outside the chamber.

According to the above configuration, the light is emitted to the silica aerogel via an optical fiber and the transmitted light passed through the silica aerogel is received. Thus, the precision in detecting the fluctuation in moisture content is further improved even if light is emitted to the silica aerogel from outside the chamber.

Moreover, a moisture content fluctuation detection method according to one aspect disclosed herein is a moisture content fluctuation detection method including: emitting, by a light source, light to a silica aerogel placed, exposed to a measurement object space, the light having at least a portion of a range of wavelengths of 1850 nm or greater and 1970 nm or less; receiving, by a light receiving unit, light that has passed through the silica aerogel and has at least a portion of the range of wavelengths of 1850 nm or greater and 1970 nm or less; and calculating, by a calculation unit, fluctuation in moisture within the measurement object space, based on light intensity of the light received by the light receiving unit

According to the above configuration, even if the moisture concentration in the measurement object space significantly changes, moisture content can be continuously monitored in a responsive manner, without changeover operation. Thus, feedback for process control can be quickly provided by detecting a rapid fluctuation in moisture content during the process.

Moreover, a vacuum gauge according to one aspect of disclosed herein is a vacuum gauge including: a silica aerogel placed, exposed to a measurement object space; and a detection unit configured to detect pressure fluctuation within the measurement object space, the detection unit including: a light source for emitting light to the silica aerogel, the light having at least a portion of a range of wavelengths of 1850 nm or greater and 1970 nm or less; a light receiving unit configured to receive light that has passed through the silica aerogel and has at least a portion of the range of wavelengths of 1850 nm or greater and 1970 nm or less; a thermometer for measuring a temperature within the measurement object space; and a calculation unit configured to calculate the pressure fluctuation within the measurement object space, based on light intensity of the light received by the light receiving unit and the temperature measured by the thermometer.

According to the above configuration, the fluctuation in wide bandwidth pressure (the vacuum degree) can be continuously monitored in a responsive manner, without changeover operation. Thus, feedback for process control can be quickly provided by detecting a rapid fluctuation in vacuum degree during the vacuum process.

Moreover, the silica aerogel may have: through holes having pore sizes of 10 nm or greater; a specific surface area of 400 m²/g or greater and 800 m²/g or less; and a density of 50 kg/m³ or greater and 500 kg/m³ or less.

According to the above configuration, since the silica aerogel includes the through holes that have sizes 10-fold or greater as compared to closed pores of a silica gel, the specific surface area is larger as well. Thus, the fluctuation in moisture content can be efficiently detected and the fluctuation in vacuum degree can be measured.

Moreover, the detection unit further may include a light intensity storage unit configured to store light intensity of received light, and the calculation unit may refer to a relationship between change in light intensity and fluctuation in moisture content in association, based on a difference between the light intensity of the light received by the light receiving unit and the light intensity stored in the light intensity storage unit, and calculate pressure fluctuation, based on the fluctuation in moisture content and the temperature measured by the thermometer.

Moreover, the calculation unit may refer to the light intensity of the light received by the light receiving unit and a relationship between change in light intensity and fluctuation in moisture content in association and calculate moisture content per unit volume.

According to the above configuration, the fluctuation in vacuum degree can be precisely detected. Moreover, the vacuum degree can be quantitatively measured.

Moreover, the light emitted by the light source may further have at least a portion of a range of wavelengths of 600 nm or greater and less than 1850 nm or a portion of a range of wavelengths of 1970 nm or greater and 2000 nm or less, the light receiving unit may further receive light having at least a portion of the range of wavelengths of 600 nm or greater and less than 1850 nm or a portion of the range of wavelengths of 1970 nm or greater and 2000 nm or less, and the calculation unit may calculate the pressure fluctuation within the measurement object space from change in the temperature measured by the thermometer and change in ratio between light intensity of the light that is received by the light receiving unit and has at least a portion of the range of wavelengths of 600 nm or greater and less than 1850 nm or a portion of the range of wavelengths of 1970 nm or greater and 2000 nm or less and light intensity of the light having at least a portion of the range of wavelengths of 1850 nm or greater and 1970 nm or less.

According to the above configuration, the fluctuation in moisture content can be precisely detected, without the effect, if any, of variation in transmittance of the silica aerogel during measurement.

Moreover, the measurement object space may be a space within a variable pressure chamber, the chamber may include one or more measurement windows through which light is allowed to transmit, the light having at least a portion of the range of wavelengths of 1850 nm or greater and 1970 nm or less, the light emitted by the light source disposed outside the chamber may be emitted through the one or more measurement windows to the silica aerogel placed within the chamber, and the light emitted to the silica aerogel that has passed through the silica aerogel may be received through the one or more measurement windows by the light receiving unit disposed outside the chamber.

According to the above configuration, the configuration inside the chamber can be minimized. Thus, the fluctuation in vacuum degree can be precisely detected.

Moreover, the measurement object space may be a space within a variable pressure chamber, the chamber may include one or more measurement windows through which light having at least a portion of the range of wavelengths of 1850 nm or greater and 1970 nm or less and light having at least a portion of the range of wavelengths of 600 nm or greater and less than 1850 nm or a portion of the range of wavelengths of 1970 nm or greater and 2000 nm or less are allowed to pass, the light emitted by the light source disposed outside the chamber may be emitted through the one or more measurement windows to the silica aerogel placed within the chamber, and the light emitted to the silica aerogel that has passed through the silica aerogel may be received through the one or more measurement windows by the light receiving unit disposed outside the chamber.

Moreover, the measurement object space may be a space within a variable pressure chamber, the light source and the light receiving unit may be disposed outside the chamber, the light emitted by the light source may be emitted via an emitting optical fiber to the silica aerogel placed within the chamber, and the light emitted to the silica aerogel that has passed through the silica aerogel may be received via a receiving optical fiber by the light receiving unit disposed outside the chamber.

According to the above configuration, the light is emitted to the silica aerogel via an optical fiber and the transmitted light passed through the silica aerogel is received. Thus, the precision in detecting the fluctuation in vacuum degree is further improved even if light is emitted to the silica aerogel from outside the chamber.

Moreover, a vacuum degree fluctuation detection method according to one aspect disclosed herein is a vacuum degree fluctuation detection method including: emitting, by a light source, light to a silica aerogel placed, exposed to a measurement object space, the light having at least a portion of a range of wavelengths of 1850 nm or greater and 1970 nm or less; receiving, by a light receiving unit, light that has passed through the silica aerogel and has at least a portion of the range of wavelengths of 1850 nm or greater and 1970 nm or less; measuring, by a thermometer, a temperature within the measurement object space; and calculating, by a calculation unit, pressure fluctuation within the measurement object space, based on light intensity of the light received by the light receiving unit and the temperature measured by the thermometer.

According to the above configuration, the wide bandwidth pressure (the vacuum degree) can be continuously monitored in a responsive manner. Thus, feedback for process control can be quickly provided by detecting a rapid fluctuation in vacuum degree during the vacuum process.

Hereinafter, certain exemplary embodiments are described in greater detail with reference to the accompanying Drawings.

Each of the exemplary embodiments described below shows a general or specific example. The numerical values, shapes, materials, structural elements, the arrangement and connection of the structural elements, steps, the processing order of the steps etc. shown in the following exemplary embodiments are mere examples, and therefore do not limit the scope of the appended Claims and their equivalents. Therefore, among the structural elements in the following exemplary embodiments, structural elements not recited in any one of the independent claims are described as arbitrary structural elements.

### Embodiment 1

Hereinafter, Embodiment 1 according to one aspect disclosed herein will be described, with reference to the accompanying drawings. In the following, the same reference signs will be used to refer to the same or corresponding components throughout the drawings, and the description of the components will not be repeated.

[Configuration of Moisture Content Fluctuation Detection Device]

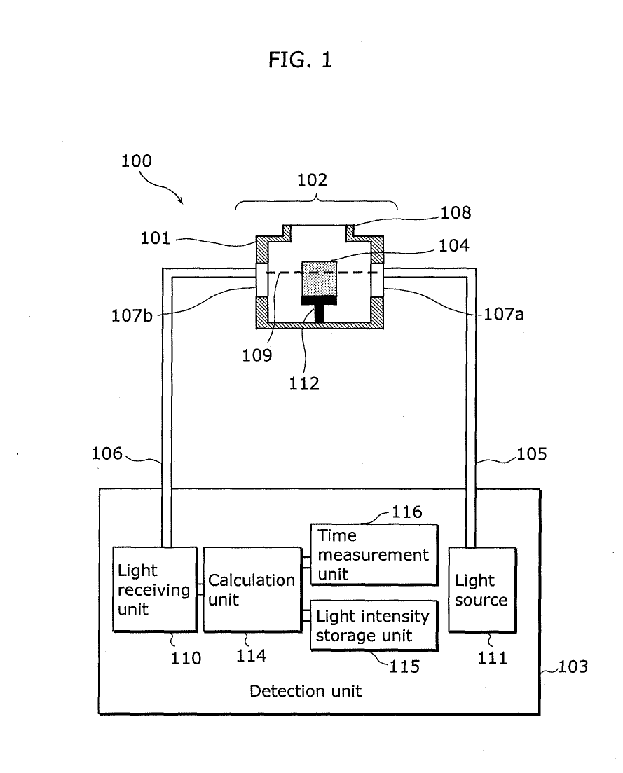

FIG. 1 is a schematic view showing an example of a moisture content fluctuation detection device according to the present embodiment.

A moisture content fluctuation detection device 100 shown in FIG. 1 includes a sensor unit 102 and a detection unit 103. The moisture content fluctuation detection device 100 detects fluctuation in moisture content in a measurement object space.

The sensor unit 102 includes a sensor chamber 101, a silica aerogel 104, a platform 112, and measurement windows 107a and 107b. The silica aerogel 104 is placed on the platform 112 inside the sensor chamber 101. The platform 112 is fixed to the interior sidewall of the sensor chamber 101.

The sensor chamber 101 includes the two measurement windows 107a and 107b. Light enters from the measurement window 107a to the interior of the sensor chamber 101. The entered light exits from the measurement window 107b to outside of the sensor chamber 101. In other words, light passes through the interior of the sensor chamber 101 via the measurement windows 107a and 107b. The light which passes through the sensor chamber 101 includes, as described below, at least a portion of a range of wavelengths of 1850 nm or greater and 1970 nm or less.

The two measurement windows 107a and 107b are provided on opposite sides of the silica aerogel 104. This allows the light that is passing through the sensor chamber 101 to pass through the silica aerogel 104. It should be noted that the sensor chamber 101 is not limited to include only the two measurement windows 107a and 107b, and may include a plurality of measurement windows so that light can pass through the interior of the sensor chamber 101.

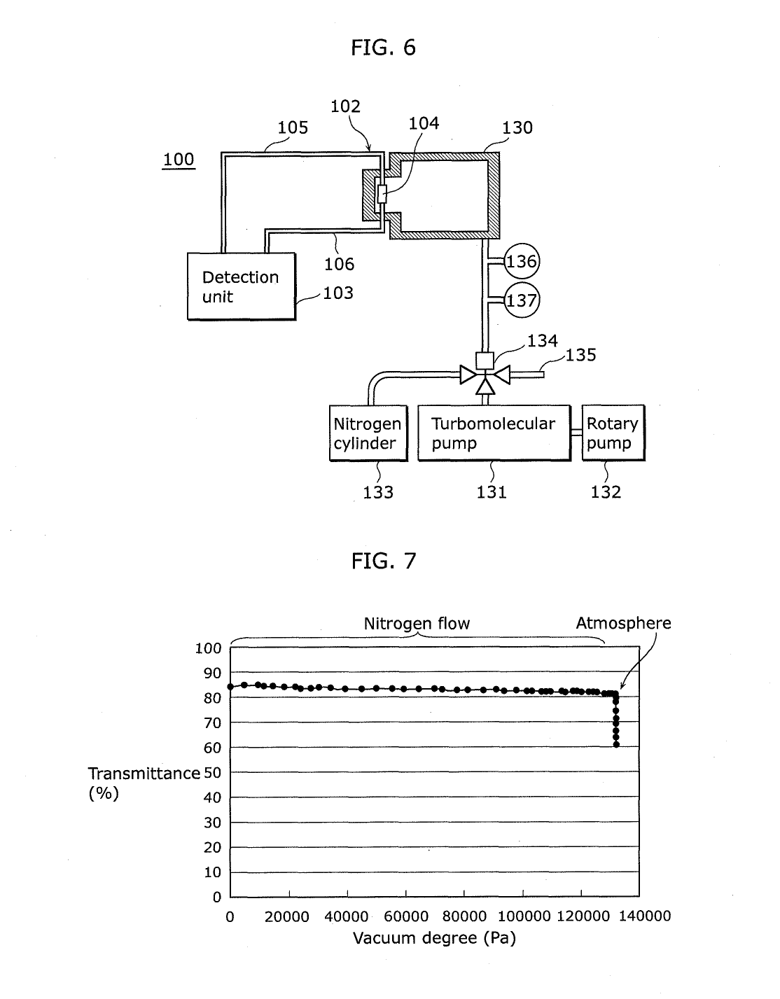

The sensor unit 102 is connected to a process chamber 130 (see FIG. 6) which is to be a measurement object space described below, via a connection 108 of the sensor chamber 101. The measurement object space (the process chamber 130) is disposed in at least the same atmosphere as that for the silica aerogel 104. In other words, gas and moisture in the measurement object space may be movable into the interior of the sensor chamber 101. For example, the sensor chamber 101 may be connected to the measurement object space. Alternatively, the sensor chamber 101 may be disposed inside the measurement object space. At this point, the sensor chamber 101 has pores having sizes which permit the gas in the measuring space to pass therethrough. The gas in the measurement object space moves to the sensor chamber 101 through the pores. If the sensor chamber 101 is configured with mesh or the like, for example, the mesh corresponds to the pores.

The silica aerogel 104 may be placed on the platform 112 without being fixed thereto, or may be placed fixed onto the platform 112 by adhesive (for example, such as an epoxy resin) or the like. It should be noted that the silica aerogel 104 may be placed fixed to the interior sidewall of the process chamber 130. In this case, the sensor unit 102 is configured with the silica aerogel 104 only.

The silica aerogel 104 is placed, exposed in the measurement object space (the process chamber 130). Being disposed, herein, means that the silica aerogel is placed in a space having substantially the same moisture content as that in the atmosphere of the measurement object space, as described above.

The detection unit 103 includes at least a light source 111, a light receiving unit 110 which detects light intensity, and a calculation unit 114. The light source 111 emits light to the silica aerogel 104. The light receiving unit 110 receives light passed through the silica aerogel 104.

The light source 111 may emit light to the silica aerogel 104 via an emitting optical fiber 105. The emitting optical fiber 105 has one end connected to the light source 111 and the other end connected to the measurement window 107a. Likewise, the light receiving unit 110 may receive light passed through the silica aerogel 104 via a receiving optical fiber 106. The receiving optical fiber 106 has one end connected to the measurement window 107b and the other end connected to the light receiving unit 110. The light emitted from the light source 111 passes through the silica aerogel 104 via the emitting optical fiber 105 and the measurement window 107a. The emitted measurement light 109 passes through the silica aerogel 104 and reaches the light receiving unit 110 in the detection unit 103 via the measurement window 107b and the receiving optical fiber 106. The light emitted from the light source 111 may be guided to the measurement window 107a, using the emitting optical fiber 105, or may be guided to the silica aerogel 104, using the emitting optical fiber 105. Alternatively, the light may be guided to the silica aerogel 104 without the emitting optical fiber 105.

It should be noted that when the silica aerogel 104 is placed exposed in the measurement object space (the process chamber 130) or the like, the emitting optical fiber 105 and the receiving optical fiber 106 may be directly connected to the process chamber 130, instead of the measurement windows 107a and 107b. The emitting optical fiber 105 and the receiving optical fiber 106 are disposed on opposite sides of the silica aerogel 104.

The sensor unit 102 and the detection unit 103 may be configured as separate components as described above, or the sensor unit 102 and the detection unit 103 may be configured as one component. For example, if the measurement object space is explosion-proof or explosion-resistant, the sensor unit 102 and the detection unit 103 may better be separately configured. In that case, the sensor chamber 101 of the sensor unit 102 is configured explosion-proof or explosion-resistant. Moreover, the sensor unit 102 and the detection unit 103 may better be configured as separate components as well if the measurement object space may be pressurized or decompressed so that the sensor chamber 101 can be pressurized or decompressed.

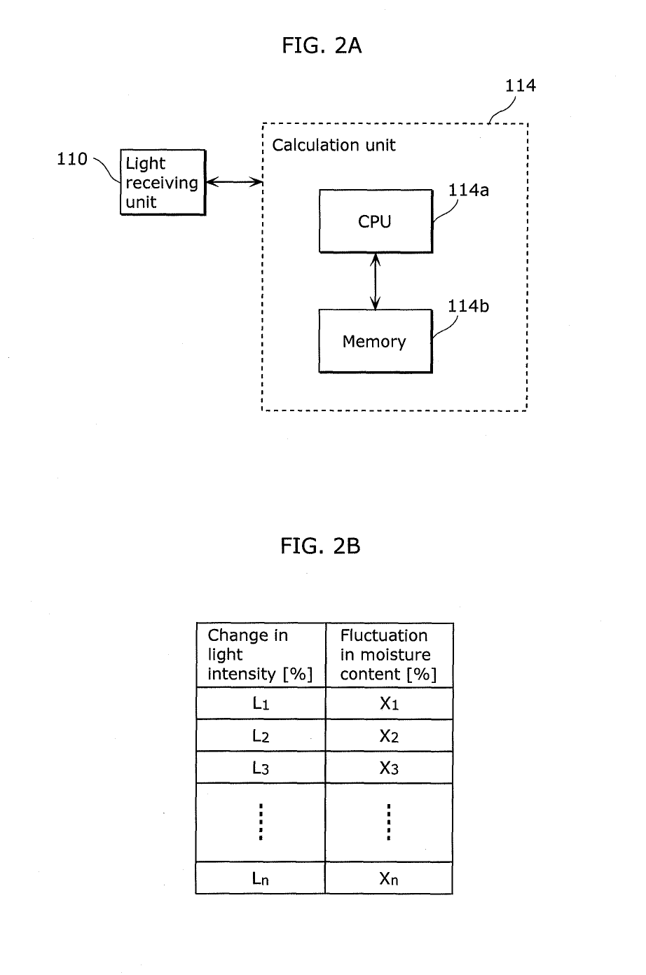

The calculation unit 114 calculates the fluctuation in moisture content, based on the light intensity of the light received by the light receiving unit 110. The calculation unit 114 is connected wired or wirelessly to the light receiving unit 110, and transmits and receives information to and from the light receiving unit 110. FIG. 2A is a block diagram of an example configuration of the calculation unit 114. FIG. 2B is a diagram showing an example of a table including values of change in light intensity and values of fluctuation in moisture content.

As shown in FIG. 2A, the calculation unit 114 includes a CPU 114a which, for example, performs a calculation process on the fluctuation in moisture content, and a memory 114b.

The CPU 114a included in the calculation unit 114 refers to the relationship (for example, the table shown in FIG. 2B described below), which is stored in the memory 114b, between the change in light intensity and the fluctuation in moisture content in association, and calculates the fluctuation in moisture content, based on the light intensity of light received by the light receiving unit 110.

For example, the CPU 114a included in the calculation unit 114 calculates a difference between the light intensity of light immediately previously received and the light intensity of light just received. The CPU 114a refers to the relationship between the change in light intensity and the fluctuation in moisture content in association to calculate a value corresponding to the calculated difference in light intensity, as a fluctuation in moisture content in the measurement object space between the immediately previous light reception and that of this time.

Moreover, a light intensity storage unit 115 included in the detection unit 103 stores therein the light intensity of light received by the light receiving unit 110. Here, it is desirable that the light intensity of the received light is stored in the light intensity storage unit 115 in a time sequential order.

The CPU 114a included in the calculation unit 114 may calculate a value of fluctuation in moisture content, using a difference between the light intensity of light just received and the light intensity of light previously received not limiting to the light intensity of light immediately previously received. For example, the detection unit 103 may include, as shown in FIG. 1, a time measurement unit 116, and store the light intensity in association with a time at which the light is received by the light receiving unit 110 into the light intensity storage unit 115. This allows the calculation unit 114 to calculate the fluctuation in moisture content over time, using the calculated fluctuation in moisture content and the difference between the time at which the light intensity of light is immediately previously received and the time at which the light intensity of light just received.

The calculation unit 114 may calculate a total sum of the moisture content within the process chamber 130 which is the measurement object space, or calculate moisture content per unit volume.

The calculation unit 114 may previously store the relationship between the change in light intensity and the fluctuation in moisture content in association into the memory 114b included in the calculation unit 114 and refer to the relationship, or may obtain the relationship from an external storage unit (not shown) of the calculation unit 114.

The relationship between the change in light intensity and the fluctuation in moisture content in association may be presented in a table which includes values of change in light intensity and values of fluctuation in moisture content, or a function whereby a value of fluctuation in moisture content is derived using a value of change in light intensity as a variable.

FIG. 2B shows an example of the table including values of change in light intensity and values of fluctuation in moisture content. The CPU 114a included in the calculation unit 114 refers to the table shown in FIG. 2B for a value corresponding to a value corresponding to the calculated light intensity and calculates fluctuation in moisture content. The calculation unit 114 outputs a value of the calculated fluctuation in moisture content. For example, according to the table shown in FIG. 2B, X₂ [%] is referred to for the fluctuation in moisture content when the light intensity is L₂ [%].

[Principle of Measurement of Moisture Content]

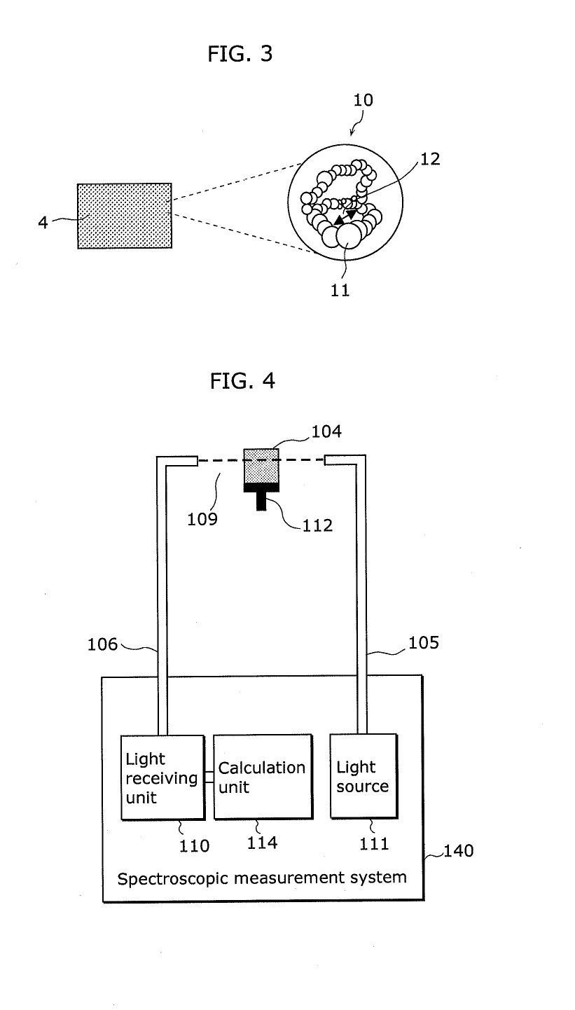

Here, description will be given with respect to principle of measurement of the moisture content, that is, principle of measurement of the density of water molecule in the moisture content fluctuation detection device according to the present embodiment. The above-described silica aerogel is used for measurement of the density of water molecule. FIG. 3 is a schematic diagram showing the structure of the silica aerogel.

A silica aerogel 4 has a structure depending on a fabrication method. Silica particles 11 having sizes of about 10 nm are formed from a liquid-sol prepared by mixing silica alkoxide as a starting material, alcohol as solvent, and ammonia water as catalyst. The backbone of a wet gel 10 is formed by the silica particles 11 bonding to one another. The silica aerogel 4 are prepared by replacing (drying) the liquid of the wet gel 10 with a gas in a way that the backbone is not shrank. Supercritical drying is a general drying method.

The silica aerogel 4 has a porosity of 80% or greater. The silica aerogel 4 has an extremely large porosity, as compared to the porosity of a silica gel. Pores of the silica aerogel are formed of, as shown in FIG. 3, the silica particles 11 forming the backbone of the silica aerogel 4, and through holes 12 of the silica particles 11. A distance between the silica particles 11 forming the through hole 12 (i.e., pore size) is about 20 nm or greater and about 60 nm or less. The silica aerogel includes the through holes 12 that have sizes 10-fold or greater as compared to closed pores of a silica gel. The density of the silica aerogel 4 is as small as 50 kg/m³ or greater and 500 kg/m³ or less. Thus, the specific surface area is as large as 400 m²/g or greater and 800 m²/g or less, despite of the large pore sizes.

Furthermore, each of the silica particles 11 forming the backbone of the silica aerogel 4 is small, and thus the silica aerogel 4 is translucent. While the silica particles 11 are formed by siloxane bond, a large number of unreacted silanol groups remain. In other words, a large number of silanol groups are on the surfaces of the through holes, thereby efficiently trapping moisture in the atmosphere. The through holes 12 between the silica particles 11 are exposed to the surrounding environment, passing through in various directions. Thus, the through holes 12 adsorb and release moisture, in accordance with ambient moisture, the response rate of which is high.

Here, transmission spectrum when light is emitted to the silica aerogel will be described.

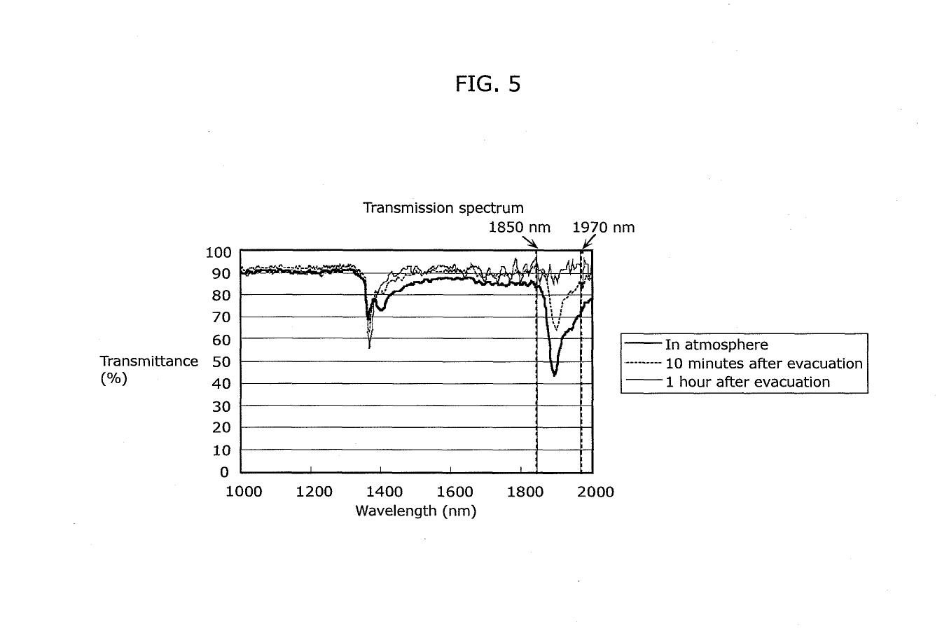

FIG. 4 is a schematic view of the measurement system when the transmission spectrum of the silica aerogel is measured. FIG. 5 is a diagram showing an example of the transmission spectrum of the silica aerogel. FIG. 5 shows results of measuring, by a spectroscopic measurement system (Array Spectrometer MCPD-9800 made by Otsuka Electronics Co., Ltd.), transmission spectrum of the silica aerogel 4 disposed in the atmosphere for light having a light wavelength of 1000 nm or greater and 2000 nm or less.

As shown in FIG. 4, the measurement system for the transmission spectrum of the silica aerogel includes the silica aerogel 104, the emitting optical fiber 105, the receiving optical fiber 106, the platform 112, and a spectroscopic measurement system 140. The spectroscopic measurement system 140 includes the light receiving unit 110 and the light source 111.

The light source 111 is configured with, for example, a halogen lamp. It should be noted that the light source 111 is not limited to a halogen lamp and may be a white light source such as Xenon lamp. The light source 111 may also be an LED light source, a laser light source, or the like which can emit light at least a portion of a range of wavelengths of 1850 nm or greater and 1970 nm or less.

The light receiving unit 110 detects the light intensity of light at least having a portion of the range of wavelengths of 1850 nm or greater and 1970 nm or less. For example, a photoelectric conversion element such as a photodiode is used. If a white light source is used for the light source 111, a necessary wavelength is isolated using a diffraction grating, a prism, or the like between the receiving optical fiber 106 and the light receiving unit 110, and its light intensity is detected. For example, the spectroscopic measurement system 140 may be used for the detection unit 103.

The light emitted from the light source 111 in the spectroscopic measurement system 140 is guided to the silica aerogel 104 by the emitting optical fiber 105, and emitted onto a measurement unit of the silica aerogel 104, and furthermore, the measurement light 109 emitted onto the measurement unit of the silica aerogel 104 is received by the receiving optical fiber 106 and guided to the light receiving unit 110 of the spectroscopic measurement system 140.

Procedure for the measurement will be described. First, baseline measurement is performed. Specifically, the silica aerogel 104 is removed from the platform 112 and the measurement light 109 passed through the atmosphere is measured as a baseline. Next, transmission spectrum measurement is performed. In the transmission spectrum measurement, the silica aerogel 104 is placed on the platform 112, and the measurement light 109 that has passed through the silica aerogel 104 is measured.

Here, an example of the transmission spectrum of the measured measurement light 109 is shown in FIG. 5.

It can be seen from FIG. 5 that the transmission spectrum absorption of the measured silica aerogel 104 is mainly at near wavelengths of 1400 nm and 1900 nm. According to a reference (Introduction of Near-infrared Spectroscopy (P. 45, 46) Mutsuo IWAMOTO et al., Saiwai Shobo, September 1994), the reduced portions of the transmittance indicated near the wavelengths of 1400 nm and 1900 nm are both spectrum absorption by a hydroxyl group (O—H) of moisture adsorbed onto the silica aerogel 104. In other words, increased light absorption by the silica aerogel 104 and reduced transmittance near the wavelengths of 1400 nm and 1900 nm denote that moisture content in the measurement object space is high. In contrast, small spectrum absorption near the wavelengths of 1400 nm and 1900 nm and increased transmittance denote that moisture content in the measurement object space is low.

According to FIG. 5, a measurement result is obtained that light absorption by moisture, particularly near the wavelength of 1900 nm is extremely enhanced. A measurement result is obtained that spectrum absorption by moisture near the wavelength of 1900 nm is three times greater in extinction coefficient than spectrum absorption by moisture near the wavelength of 1400 nm.

In the course of preparing the silica aerogel 104, alcohol solvent such as ethanol is used. Thus, it is conceived that a peak of spectrum absorption due to residual alkyl group (C—H) is, in some degree, included in the measurement result shown in FIG. 5. In general, the spectrum absorption wavelength by an alkyl group occurs near 1400 nm (1395 nm, 1415 nm). Thus, the reduction of the transmittance seen near 1400 nm in the measurement result shown in FIG. 5 is believed to be due to mingling of the spectrum absorption wavelength by the alkyl group and the spectrum absorption by a hydroxyl group (O—H). Thus, it is difficult to distinguish between the range of the peak of the spectrum absorption by the alkyl group and the range of the peak of the spectrum absorption by the hydroxyl group (O—H) near 1400 nm.

Thus, in FIG. 5, an amount corresponding to the change in spectrum absorption near the wavelength of 1900 nm, specifically, the wavelengths of 1850 nm or greater and 1970 nm or less is regarded to be the fluctuation in moisture content in the measurement object space.

Moreover, no particular peak of the spectrum absorption is observed in FIG. 5 at wavelengths other than near 1400 nm and near 1900 nm. In the measurement, the light transmittance through the silica aerogel 104 does not reach 100% either. For example, the transmittance of light at a wavelength of 1240 nm is 70%. The spectrum is absorbed at the wavelength of 1240 nm because the light is scattered or absorbed due to the structure of the silica aerogel 104. In other words, it can be seen that the loss of light due to the silica aerogel 104 is 30%.

On the other hand, FIG. 5 shows that the light transmittance in the wavelength of 1900 nm is 40% and thus the loss of light is 60%. Subtracting 30% as the loss of light due to the silica aerogel 104 from the loss of light 60%, spectrum absorption generated by the silica aerogel 104 trapping moisture in the atmosphere is 30%. This amount of spectrum absorption indicates that the light having the wavelength of 1900 nm has a large sensitivity to the moisture content.

Thus, to measure the moisture content in the measurement object space from the transmission spectrum of the silica aerogel 104, it is desirable to measure the fluctuation in moisture content in the measurement object space by detecting the change in transmittance of the light near the wavelength of 1900 nm. However, since, in general, extinction coefficient due to a hydroxyl group (O—H) is large, the spectrum ends up saturated if the silica aerogel 104 contains 20% or more of moistures. Thus, the moisture in the silica aerogel 104 needs to be less than 20% relative to the weight of the silica aerogel 104. Considering that the silica aerogel 104 traps moisture in the atmosphere, the moisture in the silica aerogel 104 is more preferably less than 10% relative to the weight of the silica aerogel 104.

[Method of Detecting Fluctuation in Moisture Content]

Next, an example of the method of detecting the fluctuation in moisture content will be described.

The moisture content fluctuation detection device 100 according to Embodiment 1 detects fluctuation in moisture content, using change in light intensity of light which has at least a portion of the range of wavelengths of 1850 nm or greater and 1970 nm or less.

FIG. 6 is a schematic view of a configuration for detecting the fluctuation in moisture content in the process chamber 130. The process chamber 130 and the sensor unit 102 are connected each other at the connection 108 shown in FIG. 1. The interior of the sensor chamber 101 and the interior of the process chamber 130 are the same space. The process chamber 130 is connected to a turbomolecular pump 131 and a rotary pump 132 via a three-way valve 134, and gas inside the process chamber 130 is evacuated by the turbomolecular pump 131 and the rotary pump 132. Also, the process chamber 130 is connected to a nitrogen cylinder 133 via the three-way valve 134, and can be filled with nitrogen. Furthermore, the process chamber 130 can expose the interior of the process chamber 130 to ambient atmosphere through piping 135 via the three-way valve 134. Pressure within the process chamber 130 is calculated by calculating a vacuum degree by a vacuum gauge disposed inside the process chamber 130. The measurement is performed using a capacitance manometer 136 (CCMT-1000A made by ULVAC) and the ionization gauge 137 (GI-TL3 made by ULVAC). The capacitance manometer 136 performs the measurement at 1.3×10¹ Pa to 1.3×10⁵ Pa, the ionization gauge 137 performs the measurement at 1×10⁻¹ Pa to 1×10⁻⁵ Pa.

Examples of the process chamber 130 include a chamber intended to deposition and modification treatment, such as a CVD device, a plasma processing apparatus, and a vapor deposition apparatus, a chamber intended to fabricate a lamp such as electric bulb and fluorescent lamp and produce imagers such as PDP, and a chamber intended for removal and cleaning such as an etching process. In other words, the measurement object space is a space configured to have a vacuum degree below a certain value. For example, the top surface, the bottom surface, and the side surface of the measurement object space are surrounded by a wall.

A halogen lamp is used for the light source 111, and the light receiving unit 110 detects the light intensity of light that has a wavelength of 1896 nm.

The method for detecting the fluctuation in moisture content will be described. First, moisture content (hereinafter, denoted also as, “baseline”) in the atmosphere without the silica aerogel 104 is measured. The baseline measurement is useful for performing highly precise measurement minus the measurement windows 107 or the atmospheric absorption. The baseline is measured in a state where the interior of the process chamber 130 is exposed to the atmosphere, the silica aerogel 104 is removed, and the measurement light 109 is allowed to pass through the atmosphere.

Next, the silica aerogel 104 is placed on the platform 112 and the measurement of the fluctuation in moisture content starts. The fluctuation in moisture content is measured by applying a predetermined vacuum to the process chamber 130, using the turbomolecular pump 131 and the rotary pump 132, and then detecting the light transmittance of the silica aerogel 104.

An example of the measurement of the fluctuation in moisture content will be described below. In the measurement example shown below, after the above-described baseline measurement, the process chamber 130 is vacuumed at about 10⁻⁴ Pa, using the turbomolecular pump 131 and the rotary pump 132. Then, introduction of nitrogen gas from the nitrogen cylinder 133 into the process chamber 130 starts and the vacuum degree is gradually decreased. After the pressure in the process chamber 130 reaches 1.3×10⁵ Pa, the process chamber 130 is exposed to the atmosphere through the piping 135.

Here, an example of a result of detecting the fluctuation in moisture content since the start of introduction of nitrogen gas is shown in FIG. 7. FIG. 7 is a diagram showing a result of detecting the fluctuation in moisture content during a process of exposing the process chamber 130 in a nitrogen atmosphere to the atmosphere by the moisture content fluctuation detection device according to the present embodiment.

In FIG. 7, the change in transmittance indicates the fluctuation in moisture content. In other words, an increase in transmittance indicates a reduction of the moisture content, and a reduction in transmittance indicates an increase of the moisture content. As seen from FIG. 7, the transmittance gradually reduces by replacing the vacuum in the process chamber 130 with nitrogen gas. This indicates that the moisture content is greater in a nitrogen gas than under vacuum, and the introducing of the nitrogen gas increases the moisture content. Moreover, since the transmittance is rapidly reduced by the exposure to the atmosphere, it can be seen that the moisture content further increases.

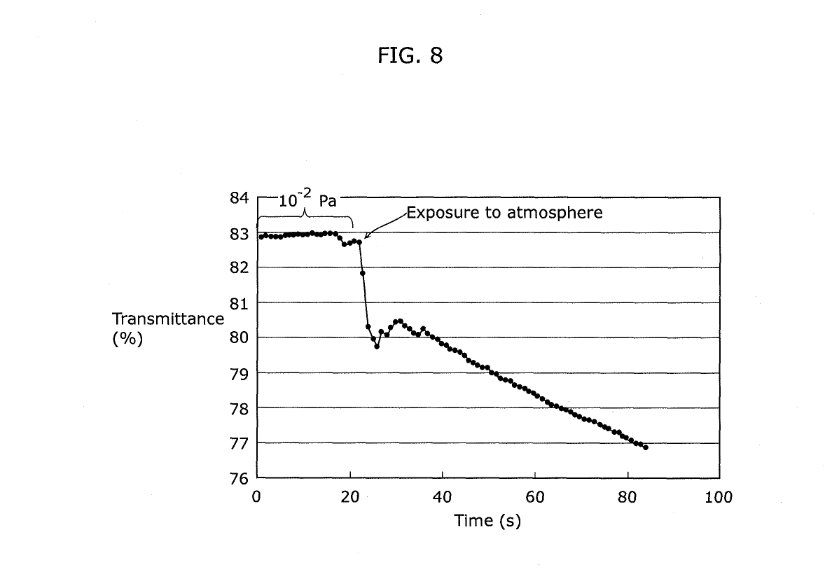

Moreover, next, the fluctuation in moisture content is measured when the process chamber 130 under high vacuum of 1×10⁻² Pa is rapidly exposed to the atmosphere. FIG. 8 is a diagram showing a result of detecting the fluctuation in moisture content during a process of exposing the process chamber 130 under high vacuum to the atmosphere by the moisture content fluctuation detection device 100 according to the present embodiment. Time is indicated on the horizontal axis because, conventionally, there has been no method which continuously measures a pressure when pressure fluctuations are rapidly generated from 1×10⁻² Pa to 1×10⁵ Pa.

In FIG. 8, rapid reduction of the transmittance is seen when about 20 hours has elapsed since the start of measurement. It is found from this result that the exposure to the atmosphere rapidly increases the moisture content. Thus, it has been found that the moisture content fluctuation detection device 100 can continuously measure the moisture content even if pressure fluctuation within the process chamber 130 is rapidly generated.

It should be noted that in this measurement, data is collected for each second by the moisture content fluctuation detection device 100. The measurement intervals are not limited to one second, and may be shorter.

Next, the time course of a result of measuring the fluctuation in moisture content with use of the silica aerogel 104 will be described.

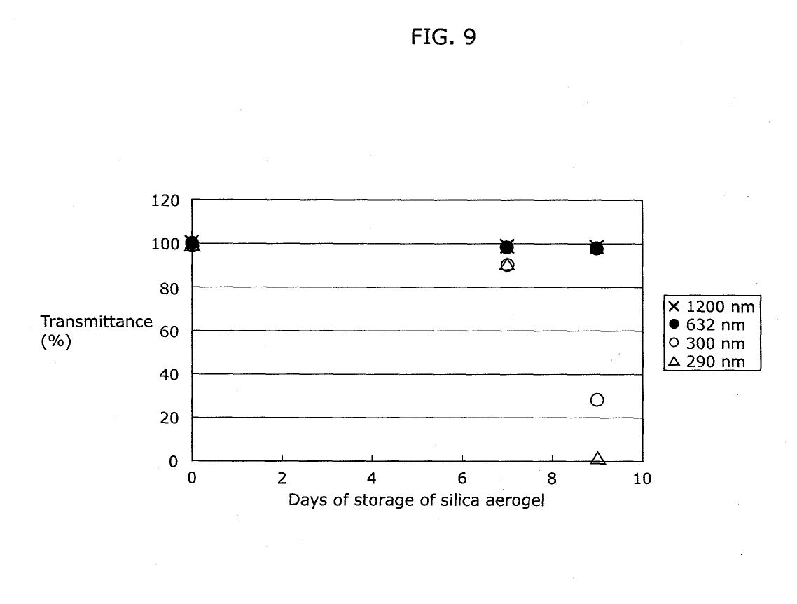

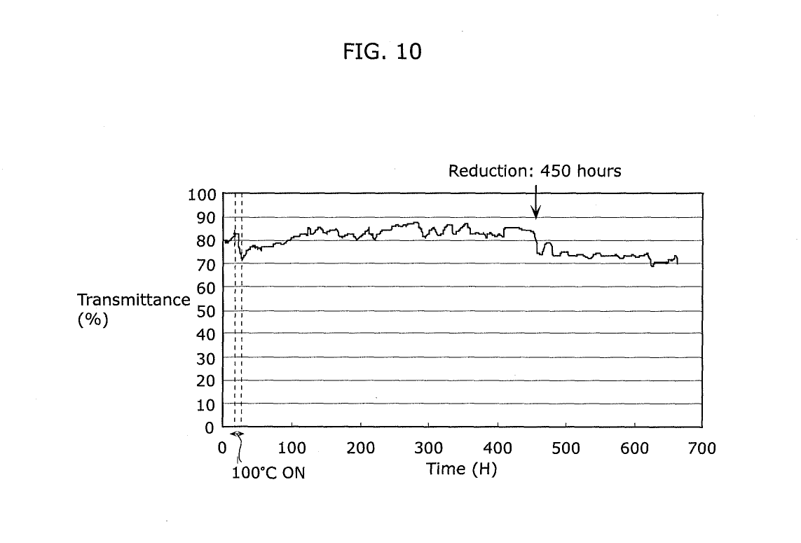

FIG. 9 is a diagram showing the light transmittance of the silica aerogel 104 at a plurality of light wavelengths relative to days of storage of the silica aerogel 104. Crosses, solid circles, open circles, and open triangles shown in the figure indicate light transmittance when the light wavelength is 1200 nm, 632 nm, 300 nm, and 290 nm, respectively, for 0 day, 7 days, and 9 days of storage. In this measurement of transmittance, for every days of storage the silica aerogel 104 is removed from vacuum and the transmittance of the silica aerogel 104 is measured under vacuum.

As shown in FIG. 9, at the light wavelengths of 1200 nm and 632 nm, little variation is seen in transmittance on 9th day of storage of the silica aerogel 104. In contrast, at the light wavelengths of 300 nm and 290 nm, the transmittance of light reduces with an increase in days of storage of the silica aerogel 104. Specifically, on 9th day of storage of the silica aerogel 104, the transmittance is about 30% when the light wavelength is 300 nm and the transmittance is a near 0% when the light wavelength is 290 nm.

The reason for the thus reduced transmittance is believed to be due to (1) a change (deterioration) in shape of the silica aerogel 104, such as condensation of the particles due to collapse of air spaces in the silica aerogel 104 and (2) occurrence of light spectrum absorption derived from a material in the measurement wavelength. A factor of the change in shape of the silica aerogel 104 is believed to be due to pressure fluctuations rather than adsorption of moisture to the silica aerogel 104.

For the cause (2), the transmittance increases by eliminating a material which causes the light spectrum absorption. Thus, the silica aerogel 104 can be continuously used for the measurement of the vacuum degree. For the cause (1), however, it is unlikely to happen that the shape of the silica aerogel 104 is restored and the transmittance improves. Therefore, from the standpoint of reliability of the measurement, it is difficult to permit continued use of the silica aerogel 104 for the measurement of the vacuum degree.

FIG. 10 is a diagram showing the transmittance of the silica aerogel at a light wavelength of 1900 nm relative to the time course of the silica aerogel.

As shown in FIG. 10, the transmittance of the silica aerogel 104 for the light in a wavelength of 1900 nm changes over time, and rapidly reduces about 20 hours and about 450 hours after the start of measurement. Here, the change in transmittance about 20 hours after the start of measurement is due to pressure changes within the sensor chamber 101 caused by setting a heater to 100° C. for degassing. The rapid change in transmittance about 450 hours after the start of measurement is believed to be due to, as with (1) described above, a change in shape of the silica aerogel 104, such as condensation of the particles due to collapse of air spaces in the silica aerogel 104. Thus, it is unlikely to happen that the shape of the silica aerogel 104 is restored and the transmittance improves. Therefore, from the standpoint of reliability of the measurement, it is difficult to permit continued use of the silica aerogel 104 after about 450 has elapsed for the measurement of the vacuum degree.

As described above, according to the moisture content fluctuation detection device 100 of the present embodiment, even if the moisture concentration in the measurement object space significantly changes, the fluctuation in moisture content can be continuously monitored in a responsive manner. Thus, feedback for process control can be quickly provided by detecting a rapid fluctuation in moisture content during the vacuum process.

While the above described baseline measurement is useful for performing highly precise measurement minus the measurement windows 107a and 107b or the atmospheric absorption, the baseline measurement is not necessary for detecting the fluctuation in moisture content. Alternatively, in addition to the baseline measurement in a state where the silica aerogel 104 is removed from measurement system, the fluctuation in moisture content may be detected by using a result of measuring a ratio of the light intensity over the light intensity of light passed through the silica aerogel 104 in a given reference state (for example, under exposure to the atmosphere).

Moreover, when quantitative measurement of the moisture content is performed, in addition to the detection of the fluctuation in moisture content, correlation data between light intensity and the moisture content may be previously created by introducing a gas of known moisture content into the process chamber 130. The quantitative measurement will be described in Embodiment 3.

Variation 1 of Embodiment 1

Next, a variation 1 of Embodiment 1 will be described. A moisture content fluctuation detection device 150 according to the variation is different from the moisture content fluctuation detection device 100 according to Embodiment 1 in that the emitting optical fiber and the receiving optical fiber are in contact with the silica aerogel in the moisture content fluctuation detection device 150.

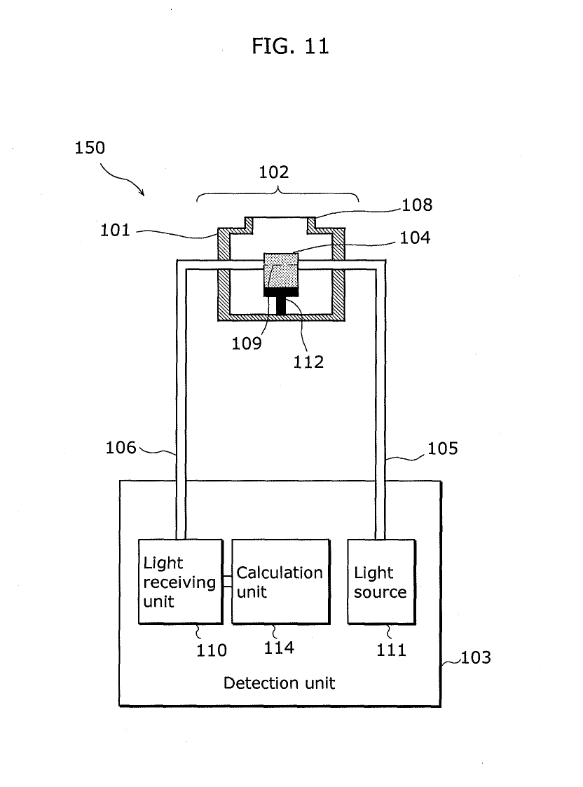

FIG. 11 is a schematic view of the configuration of the moisture content fluctuation detection device 150 according to the variation. It should be noted that the same reference signs will be used to refer to the same components as in FIG. 1.

As shown in FIG. 11, the moisture content fluctuation detection device 150 may not include the measurement windows 107a and 107b. In other words, the emitting optical fiber 105 and the receiving optical fiber 106 may be in contact with the silica aerogel 104, the light emitted from the light source 111 may be guided to the silica aerogel 104 by the emitting optical fiber 105, and the light passed through the silica aerogel 104 may be received by the receiving optical fiber 106. This configuration can efficiently improve the sensitivity of the moisture content fluctuation detection device 150, without effects from dust or the like in the measurement object space.

Variation 2 of Embodiment 1

Next, a variation 2 of Embodiment 1 will be described.

A moisture content fluctuation detection device 200 according to the variation is different from the moisture content fluctuation detection device 100 according to Embodiment 1 in that the moisture content fluctuation detection device 200 includes a plurality of silica aerogels.

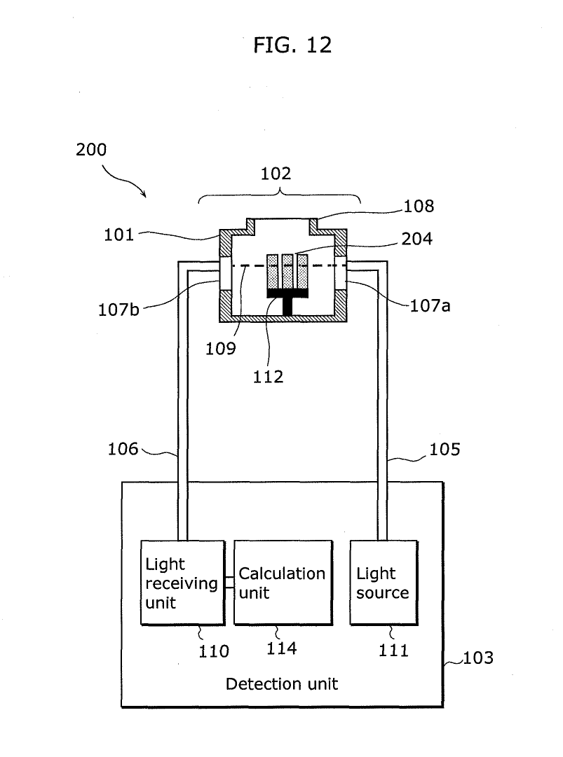

FIG. 12 is a schematic view of the configuration of the moisture content fluctuation detection device 200 according to the variation. It should be noted that the same reference signs will be used to refer to the same components as in FIG. 1.

One or more of the silica aerogel 104 may be placed in the moisture content fluctuation detection device 200. For example, as shown in FIG. 12, a plurality of the silica aerogels 104 may be placed on the platform 112. This configuration can increase the adsorption of moisture to the silica aerogel 104 and improves the sensitivity of the moisture content fluctuation detection device 200.

Variation 3 of Embodiment 1

Next, a variation 3 of Embodiment 1 will be described. A moisture content fluctuation detection device 300 according to the variation is different from the moisture content fluctuation detection device 100 according to Embodiment 1 in that the moisture content fluctuation detection device 300 includes an integrating sphere 313.

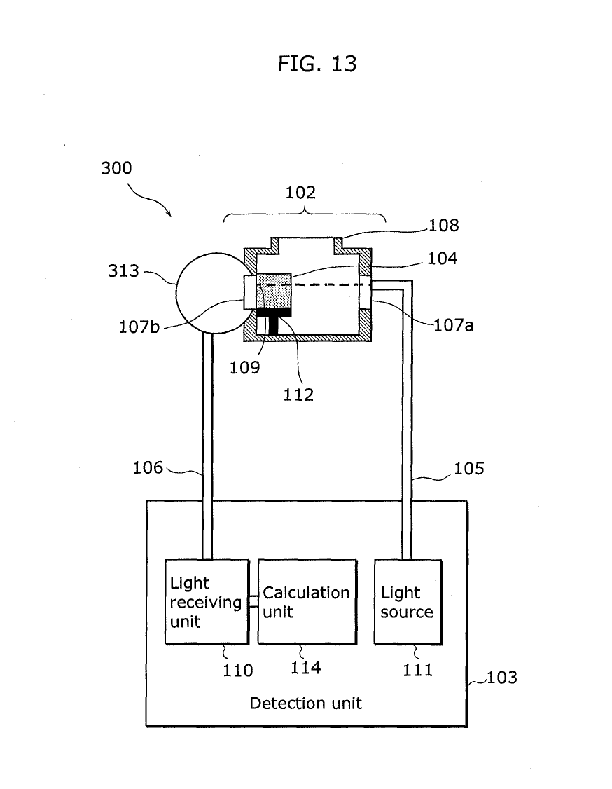

FIG. 13 is a schematic view of the configuration of the moisture content fluctuation detection device 300 according to the variation. It should be noted that the same reference signs will be used to refer to the same components as in FIG. 1.

As shown in FIG. 13, the moisture content fluctuation detection device 300 includes the integrating sphere 313 on the outside of the sensor chamber 101 at the position of the measurement window 107b where the receiving optical fiber 106 is provided. In other words, the integrating sphere 313 is disposed between the measurement window 107b and the receiving optical fiber 106. The inner surface of the integrating sphere 313 is applied with a light diffusing material such as a barium sulfate so that light incident on the integrating sphere 313 can diffuse.

The measurement light 109 passed through the silica aerogel 104 is diffused by the above-mentioned integrating sphere 313, and received by the receiving optical fiber 106, including scattered light. Use of the integrating sphere 313 reduces loss of light emitted from the silica aerogel 104 to the receiving optical fiber 106, and increases S/N, thereby improving the precision of the moisture content fluctuation detection device 300.

Variation 4 of Embodiment 1

Next, a variation 4 of Embodiment 1 will be described. A moisture content fluctuation detection device 500 according to the variation is different from the moisture content fluctuation detection device 100 according to Embodiment 1 in that the moisture content fluctuation detection device 500 includes one measurement window.

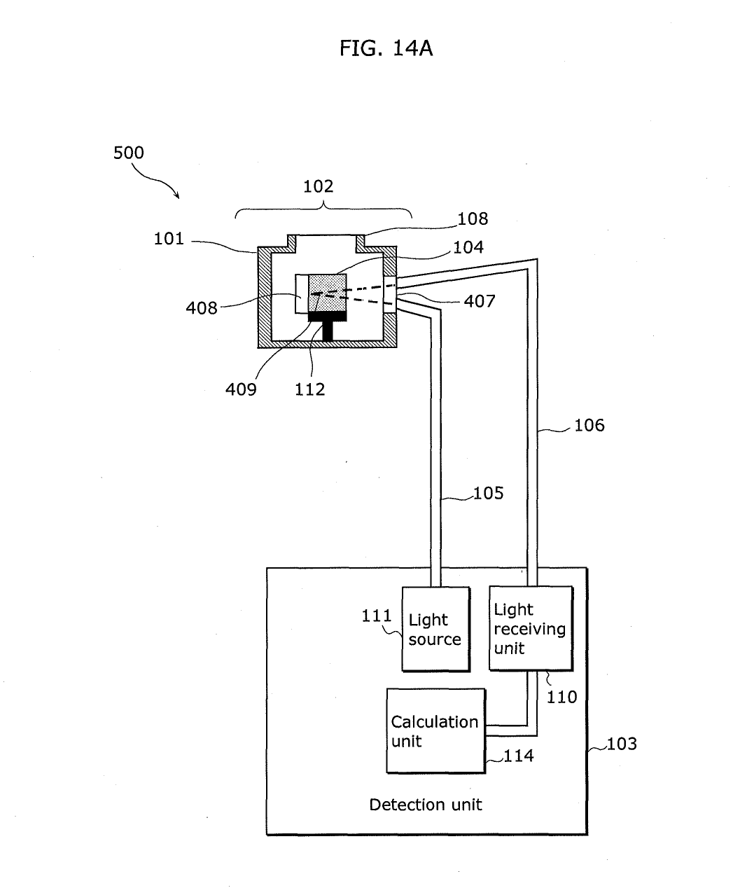

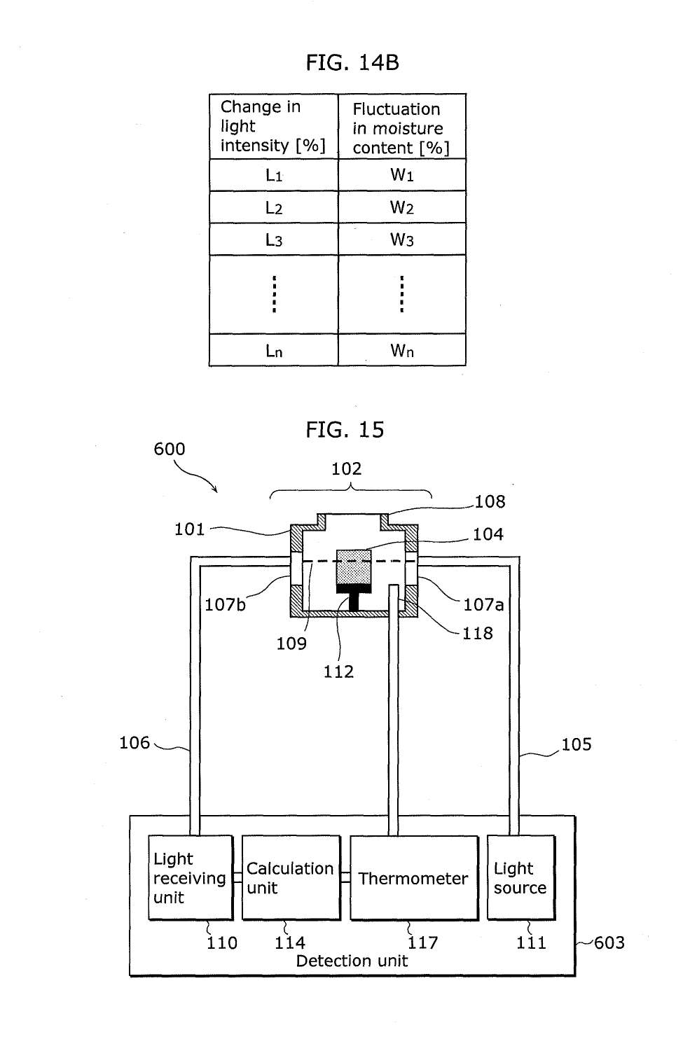

FIG. 14A is a schematic view of the configuration of the moisture content fluctuation detection device 500 according to the variation. It should be noted that the same reference signs will be used to refer to the same components as in FIG. 1.

As shown in FIG. 14A, the moisture content fluctuation detection device 500 includes a measurement window 407, and further includes the emitting optical fiber 105 and the receiving optical fiber 106 on the outside of the sensor chamber 101 at the position of the measurement window 407. Moreover, a reflector 408 is disposed on an end surface of the silica aerogel 104 opposite to a side where the measurement window 407 is disposed.

Light emitted from the emitting optical fiber 105 is guided to the silica aerogel 104, the transmitted light 409 passed through the silica aerogel 104 is reflected off the reflector 408, and the reflected light is received by the receiving optical fiber 106.

According to the above configuration, the loss of light emitted to the receiving optical fiber 106 reduces and S/N increases, thereby increasing precision of the moisture content fluctuation detection device 500.

### Embodiment 2

Next, Embodiment 2 according to one aspect disclosed herein will be described.

A moisture content fluctuation detection device according to the present embodiment is different from the moisture content fluctuation detection device according to Embodiment 1 in that the moisture content fluctuation detection device according to the present embodiment detects the fluctuation in moisture content, using a ratio in light intensity of two light beams having ranges of wavelengths. Hereinafter, description will be given, with reference to FIGS. 1, 5, and 9 shown in Embodiment 1.

The moisture content fluctuation detection device according to the present embodiment detects changes in light intensity of light having at least a portion of the range of wavelengths of 1850 nm or greater and 1970 nm or less, and light having at least a portion of a range of wavelengths of 600 nm or greater and less than 1850 nm or a portion of a range of wavelengths of 1970 nm or greater and 2000 nm or less to detect fluctuation in moisture content, using change in ratio between the light intensity of light having at least a portion of the range of wavelengths of 600 nm or greater and less than 1850 nm or a portion of the range of wavelengths of 1970 nm or greater and 2000 nm or less and the light intensity of light having at least a portion of the range of wavelengths of 1850 nm or greater and 1970 nm or less. In other words, as shown in FIG. 5, the fluctuation in moisture content can be precisely detected, without the effect, if any, of variation in transmittance of the silica aerogel during measurement by monitoring the change in ratio between: the light intensity of light having at least a portion of the range of wavelengths of 1850 nm or greater and 1970 nm or less where change in spectrum absorption due to adsorption of moisture is large; and the light intensity of light having at least a portion of the range of wavelengths of 600 nm or greater and less than 1850 nm or a portion of the range of wavelengths of 1970 nm or greater and 2000 nm or less where change in spectrum absorption due to adsorption of moisture is small.

As shown in FIG. 9, in the range of wavelengths smaller than 600 nm, the detection is sensitive to degradation of the silica aerogel 104. Thus, at least the wavelength of 600 nm is a preferable range of wavelengths where the change in spectrum absorption due to the adsorption of moisture is small.

For example, a halogen lamp is used for the light source 111 in the moisture content fluctuation detection device 100 shown in FIG. 1. In this case, one light source may be sufficient. Furthermore, using a diffraction grating for example, the light receiving unit 110 separates, from the received light, light having at least a portion of a range of wavelengths of 1850 nm or greater and 1970 nm or less and light having at least a portion of a range of wavelengths of 600 nm or greater and less than 1850 nm or a portion of the range of wavelengths of 1970 nm or greater and 2000 nm or less, and the light intensity of each of the light having the wavelengths is detected using a photoelectric conversion element such as a photodiode. The calculation unit 114 calculates a ratio between the light intensity of the light having at least a portion of the range of wavelengths of 600 nm or greater and less than 1850 nm or a portion of the range of wavelengths of 1970 nm or greater and 2000 nm or less and the light intensity of the light having at least a portion of the range of wavelengths of 1850 nm or greater and 1970 nm or less, and the fluctuation in moisture content is detected by change in the ratio.

Advantages of detecting the fluctuation in moisture content from the ratio of the light intensity of light between two wavelengths is that the fluctuation in moisture content can be precisely detected, without the effect, if any, of variation in transmittance of the silica aerogel 104 during measurement.

It should be noted that the light source 111 is not limited to the halogen lamp, and may be a white light source such as a Xenon lamp. Alternatively, an LED light source (or a laser light source) may be used which emits light having at least a portion of a range of wavelengths of 600 nm or greater and 2000 nm or less. In this case, two light sources corresponding to respective wavelength are required.

### Embodiment 3

Next, Embodiment 3 according to one aspect disclosed herein will be described.

A moisture content fluctuation detection device according to the present embodiment is different from the moisture content fluctuation detection device according to Embodiment 1 in that the moisture content fluctuation detection device according to the present embodiment measures a quantitative moisture content, while the moisture content fluctuation detection device according to Embodiment 1 measures a relative moisture content (a fluctuation in moisture content). Hereinafter, the moisture content fluctuation detection device according to the present embodiment will be described.

Quantitative moisture content can be obtained by previously creating, using standard gases, correlation data plotting a relationship between a baseline moisture content and the light intensity, and calibrating, using the correlation data, a relative vacuum degree obtained by measurement. Hereinafter, a calibration method for quantification will be described.

First, the measurement of baseline moisture content will be described. Examples of the baseline moisture content include moisture content in the atmosphere, moisture content within a vacuum chamber at a start of degassing, moisture content within a vacuum chamber under nitrogen flow, and moisture content when gas within a chamber is replaced with gas including preset moisture content. For example, correlation data between light intensity and the moisture content is previously created by introducing a gas of known moisture content into a process chamber 130

Relationship between the change in light intensity and moisture content per unit volume in the measurement object space in association is stored in a memory 114b included in a calculation unit 114 or an external storage unit (not shown), as the relationship between the change in light intensity and the fluctuation in moisture content in association. In other words, the memory 114b or the external storage unit may store therein the relationship of the change in light intensity with moisture content per unit volume in the measurement object space instead of the fluctuation in moisture content.

FIG. 14B is a diagram showing an example of a table including values of change in light intensity and values of the moisture content. The example of the relationship between the change in light intensity and moisture content per unit volume in the measurement object space in association is a table including values of the light intensity and values of moisture content per unit volume in the measurement object space, or a function whereby a value of moisture content per unit volume in the measurement object space is derived using a value of the light intensity as a variable. For example, according to the table shown in FIG. 14B, W₂ [%] is referred to for the moisture content when the light intensity is L₂ [%].

Specifically, standard gases (for example, products of Sumitomo Seika Chemicals Company Limited) are prepared in which known moisture content of 10 ppm, 50 ppm, 100 ppm, 200 ppm, 300 ppm, 400 ppm, 500 ppm are included into nitrogen gas. Then, a ratio is measured which is between the intensity of light that has at least a portion of the range of wavelengths of 600 nm or greater and less than 1850 nm or a portion of the range of wavelengths of 1970 nm or greater and 2000 nm or less and the intensity of light that has at least a portion of the range of wavelengths of 1850 nm or greater and 1970 nm or less, when the chamber is filled with each standard gas. A plot of the known moisture content indicated on the horizontal axis and the known ratio of light intensity on the vertical axis is used as correlation data between the light intensity and the moisture content.

By calibrating the known moisture content to the known ratio of the light intensity of the correlation data in the nitrogen gas atmosphere, using, for example, a calibration curve, the moisture content to the light intensity ratio measured in the nitrogen gas atmosphere can be obtained. This allows for quantitative measurement of the density of water molecule.

It should be noted that the above-described correlation data may be created using a standard gas of gas species used. While the calibration method for quantification can be used for the above-described moisture content fluctuation detection device according to Embodiment 1, more precise quantification is possible when the calibration method used in Embodiment 2 because in the moisture content fluctuation detection device according to Embodiment 2, moisture content is measured independent of variation in transmittance of the silica aerogel.

In the moisture content fluctuation detection device according to the present embodiment, the calculation unit 114 refers to the light intensity of the light received by the light receiving unit and the relationship between the change in light intensity and the moisture content in association to calculate moisture content per unit volume.

As described above, according to the moisture content fluctuation detection device of the present embodiment, quantified moisture content can be obtained by calibrating the measured relative moisture content or by referring to the relationship between the change in light intensity and moisture content per unit volume in the measurement object space in association.

### Embodiment 4

Next, Embodiment 4 according to one aspect disclosed herein will be described, with reference to the accompanying drawings. The present embodiment will illustrate use of the above-described moisture content fluctuation detection device as a vacuum gauge. In the following, the same reference signs will be used to refer to the same or corresponding components throughout the drawings, and the description of the components will not be repeated.

[Configuration of Vacuum Gage]

FIG. 15 is a schematic view showing an example of a vacuum gauge according to the present embodiment.

As shown in FIG. 15, a vacuum gauge 600 according to the present embodiment includes a sensor unit 102 and a detection unit 603.

Similarly to the sensor unit 102 provided in the moisture content fluctuation detection device 100 shown in Embodiment 1, the sensor unit 102 includes a sensor chamber 101, a silica aerogel 104, a platform 112 on which silica aerogel is placed, and a measurement windows 107a and 107b.

The detection unit 603 includes at least a light source 111, a light receiving unit 110 which detects light intensity, a calculation unit 114, and a thermometer 117 which measures a temperature within the sensor chamber 101. The light source 111 and the light receiving unit 110 have the similar configuration as the light source 111 and the light receiving unit 110 shown in Embodiment 1, respectively, and thus the description will not be repeated. Also, while not shown, the detection unit 603 may further include a time measurement unit and a light intensity storage unit as with the detection unit 103 shown in Embodiment 1.

The calculation unit 114 calculates the fluctuation in moisture content, based on the light intensity of light received by the light receiving unit 110. The calculation unit 114 is connected wired or wirelessly to the light receiving unit 110, and transmits and receives information. Similarly to the calculation unit 114 shown in Embodiment 1, the calculation unit 114 includes a CPU 114a which, for example, performs a calculation process on the fluctuation in moisture content, and a memory 114b.

The CPU 114a included in the calculation unit 114 refers to the relationship (for example, the table shown in FIG. 2B), which is stored in the memory 114b, between the change in light intensity and the fluctuation in moisture content in association, and calculates the fluctuation in moisture content, based on the light intensity of light received by the light receiving unit 110.

The CPU 114a included in the calculation unit 114 further calculates a pressure value from the calculated fluctuation in moisture content and temperature data obtained by the thermometer 117. The thermometer 117 includes a temperature sensor unit 118 which is disposed within the sensor chamber 101, and measures the temperature within the sensor chamber 101. The thermometer 117 uses a thermocouple for example.

It should be noted that when the silica aerogel 104 is placed exposed in the measurement object space (the process chamber 130) or the like, the emitting optical fiber 105 and the receiving optical fiber 106 may be directly connected to sensor chamber 101, instead of the measurement windows 107a and 107b. The emitting optical fiber 105 and the receiving optical fiber 106 are disposed on opposite sides of the silica aerogel 104. The rest of configuration is similar to the moisture content fluctuation detection device 100 according to Embodiment 1. Thus, the description will not be repeated.

Similarly to the calculation unit 114 according to Embodiment 1, the calculation unit 114 may calculate a difference between the light intensity of light immediately previously received and the light intensity of light just received. The CPU 114a may refer to the relationship between the change in light intensity and the fluctuation in moisture content in association to calculate a value corresponding to the calculated difference in light intensity, as a fluctuation in moisture content in the measurement object space between the immediately previous light reception and that of this time. Furthermore, the light intensity of light received by the light receiving unit 110 may be stored in a light intensity storage unit 115 included in the detection unit 603.

The CPU 114a may calculate a value of fluctuation in moisture content, using a difference between the light intensity of light just received and the light intensity of light previously received not limiting to the light intensity of light immediately previously received. For example, the detection unit 603 may further include a time measurement unit 116, and store the light intensity in association with a time at which the light is received by the light receiving unit 110 into the light intensity storage unit 115. This allows the calculation unit 114 to calculate the fluctuation in moisture content over time, using the calculated fluctuation in moisture content and the difference between the time at which the light intensity of light is immediately previously received and the time at which the light intensity of light just received.

The calculation unit 114 may calculate a total sum of the moisture content within the process chamber 130 which is the measurement object space, or calculate moisture content per unit volume.

The calculation unit 114 may previously store the relationship between the change in light intensity and the fluctuation in moisture content in association into the memory 114b included in the calculation unit 114 or may obtain the relationship from an external storage unit.

The relationship between the change in light intensity and the fluctuation in moisture content in association may be presented in a table which includes values of change in light intensity and values of fluctuation in moisture content, or a function whereby a value of fluctuation in moisture content is derived using a value of change in light intensity as a variable.

[Principle of Measurement of Vacuum Degree]

Here, description will be given with respect to how to obtain a pressure within the process chamber 130 by the vacuum gauge 600 according to the present embodiment, that is, principle of measurement of the vacuum degree.

The pressure within the process chamber 130 to be measured for the vacuum degree is obtained by the following.

$$\begin{matrix}[ Equation 1 ] & \\ P = \frac{n}{V} RT & ( Eq . 1 )\end{matrix}$$

where P is a pressure within the process chamber 130, V is the volume within the process chamber 130, n is the number of gaseous molecules within the process chamber 130, and T is a temperature within the process chamber 130. In other words, n divided by V is the number density of gaseous molecules within the process chamber 130. Thus, the pressure within the process chamber 130 is found by measuring the number density of gaseous molecules and the temperature within the process chamber 130.

Specifically, the density of water molecules, as a representation of gases in the process chamber 130, is measured to obtain the pressure within the process chamber 130. The pressure obtained in this way varies depending on the moisture content of a gas used to purge within a vacuum chamber. Thus, it is desirable that to calculate the vacuum degree, the same chamber and the same gases and the like as those used for the purge is used and the vacuum degree is calibrated. It should be noted that such calibration is not necessary if only pressure fluctuations are monitored.

Next, a method of measuring the density of water molecule will be described. The above-described silica aerogel is used in measurement of the density of water molecule. The silica aerogel has a structure similar to that shown in FIG. 3.

The transmission spectrum when light is emitted to the silica aerogel is also similar to the transmission spectrum illustrated in FIG. 5 with reference to Embodiment described above. Thus, in the vacuum gauge 600 according to the present embodiment, by detecting the change in transmittance of the light near the wavelength of 1900 nm, fluctuation in moisture content can be detected and additionally, the detection of the fluctuation in pressure (the vacuum degree) is possible. Since moisture adsorption and release by the silica aerogel is at a high rate, the fluctuation in vacuum degree can be detected at a high response rate.

[Method for Detecting Fluctuation in Vacuum Degree]

Next, an example method of detecting fluctuation in pressure (vacuum degree) within a chamber will be described.

The vacuum gauge 600 according to the present embodiment detects the variation in density of water molecule using change in light intensity of light which has at least a portion of the range of wavelengths of 1850 nm or greater and 1970 nm or less, and detects the fluctuation in vacuum degree within the process chamber 130 which is a measurement object, by performing calculation using the change in light intensity and temperature data.

The configuration of the process chamber 130 for detecting the fluctuation in vacuum degree is similar to the configuration shown in FIG. 6 with reference to Embodiment 1.

A halogen lamp is used for the light source 111, and the light receiving unit 110 detects the light intensity of light that has a wavelength of 1896 nm.

The method for detecting the fluctuation in vacuum degree will be described. First, a vacuum degree (hereinafter, denoted also as, “baseline”) in the atmosphere without the silica aerogel 104 is measured. The baseline measurement is useful for performing highly precise measurement minus the measurement windows 107 or the atmospheric absorption. The baseline is measured in a state where the interior of the process chamber 130 is exposed to the atmosphere, the silica aerogel 104 is removed, and the measurement light 109 is allowed to pass through the atmosphere.

Next, the silica aerogel 104 is placed on the platform 112 and the measurement of the fluctuation in vacuum degree starts. The fluctuation in vacuum degree is measured by applying a predetermined vacuum to the process chamber 130, using the turbomolecular pump 131 and the rotary pump 132, and then detecting the light transmittance of the silica aerogel 104.

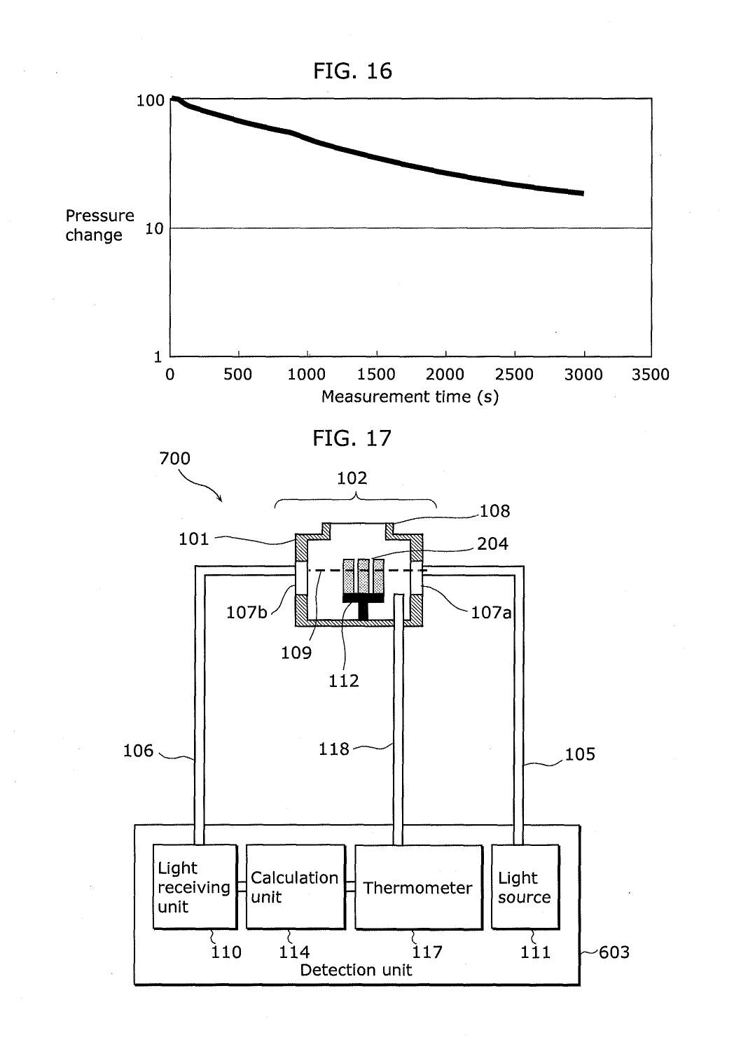

An example of the measurement of the fluctuation in vacuum degree will be described below. In the measurement example shown below, after the above-described baseline measurement, the process chamber 130 is evacuated using the rotary pump 132. Then, after the pressure in the process chamber 130 reaches 10⁻¹ Pa, the rotary pump 132 is switched to the turbomolecular pump 131 and the process chamber 130 is further evacuated. An example of a result of detecting the fluctuation in vacuum degree since the start of evacuation using the rotary pump 132 is shown in FIG. 16. FIG. 16 is a diagram showing the vacuum degree at the above-described baseline, i.e., relative fluctuation in vacuum degree per second where 100% represents the atmospheric pressure. In FIG. 16, reduction of the pressure within the process chamber 130 as compared to the atmospheric pressure is measured continuously.

It should be noted that when the vacuum degree is measured by a conventional measurement (detection) method, i.e., the vacuum degree is measured using the capacitance manometer 136 up to 1.3×10¹ Pa, and the vacuum degree is measured using an electron vacuum gauge 137 in the high vacuum region higher than 10⁻¹ Pa, its result indicates a time at which no measurement data is obtained as shown in FIG. 22, that is, a portion where the measurement data is discontinued. On the other hand, it cam be seen from FIG. 16 which shows a result of measurement of the fluctuation in vacuum degree by the vacuum gauge 600 according to the present embodiment, that the measurement data is continuous and the fluctuation in vacuum degree from the atmospheric pressure is detected in a responsive manner.

It should be noted that in this measurement, data is collected for each second. The measurement intervals are not limited for each second, and may be shorter.

It should be noted that the time course of a result of measuring the fluctuation in vacuum degree with use of the silica aerogel 104 shows a result as with FIG. 9 shown in Embodiment 1 that on 9th day of storage of the silica aerogel 104, the transmittance is about 30% when the light wavelength is 300 nm and the transmittance is a near 0% when the light wavelength is 290 nm.

In other words, in the vacuum gauge according to the present embodiment also, the reason for the reduced transmittance is believed to be due to (1) a change (deterioration) in shape of the silica aerogel 104, such as condensation of the particles due to collapse of air spaces in the silica aerogel 104 and (2) occurrence of light spectrum absorption derived from a material in the measurement wavelength. A factor of the change in shape of the silica aerogel 104 is believed to be due to pressure fluctuations rather than adsorption of moisture to the silica aerogel 104.

For the cause (2), the transmittance increases by eliminating a material which causes the light spectrum absorption. Thus, the silica aerogel 104 can be continuously used for the measurement of the vacuum degree. For the cause (1), however, it is unlikely to happen that the shape of the silica aerogel 104 is restored and the transmittance improves. Therefore, from the standpoint of reliability of the measurement, it is difficult to permit continued use of the silica aerogel 104 for the measurement of the vacuum degree.

Also, the light transmittance of the silica aerogel at a wavelength of light 1900 nm relative to the time course of the silica aerogel shows the similar result as with FIG. 10 shown in Embodiment 1.

In other words, similarly to the moisture content fluctuation detection device 100 shown in Embodiment 1, it is unlikely to happen that the shape of the silica aerogel 104 is restored and the transmittance improves. Therefore, from the standpoint of reliability of the measurement, it is difficult to permit continued use of the silica aerogel 104 after about 450 has elapsed for the measurement of the vacuum degree.

As described above, according to the vacuum gauge 600 of the present embodiment, the fluctuation in wide bandwidth pressure (the vacuum degree) can be continuously monitored in a responsive manner. Thus, feedback for process control can be quickly provided by detecting a rapid fluctuation in vacuum degree during the vacuum process.

While the above described baseline measurement is useful for performing highly precise measurement minus the measurement windows 107a and 107b or the atmospheric absorption, the baseline measurement is not necessary for detecting the fluctuation in vacuum degree. Alternatively, in addition to the baseline measurement in a state where the silica aerogel 104 is removed from measurement system, the fluctuation in vacuum degree may be detected by using a result of measuring a ratio of the light intensity over the light intensity of light passed through the silica aerogel 104 in a given reference state (for example, under exposure to the atmosphere).

Moreover, when quantitative measurement of the vacuum degree is performed, in addition to the detection of the fluctuation in vacuum degree, correlation data between light intensity, the moisture content, and a temperature may be previously obtained by introducing a gas of known moisture content into the process chamber 130. The quantitative measurement of the vacuum degree will be described in Embodiment 6.

Variation 1 of Embodiment 4

Next, a variation 1 of Embodiment 4 will be described. A vacuum gauge 700 according to the variation is different from the vacuum gauge 600 according to Embodiment 4 in that the vacuum gauge 700 includes a plurality of silica aerogels.

FIG. 17 is a schematic view of the configuration of the vacuum gauge 700 according to the variation. It should be noted that the same reference signs will be used to refer to the same components as in FIG. 15.

One or more of the silica aerogel 104 may be placed in the vacuum gauge 700. For example, as shown in FIG. 17, a plurality of the silica aerogels 104 that are thin may be placed on the platform 112. This configuration can increase the surface area of the silica aerogel 104 in contact with water molecules, thereby increasing the adsorption of moisture to the silica aerogel 104 and improving the sensitivity of the vacuum gauge 700.

Variation 2 of Embodiment 4

Next, a variation 2 of Embodiment 4 will be described. A vacuum gauge 800 according to the variation is different from the vacuum gauge 600 according to Embodiment 4 in that the vacuum gauge 800 includes the integrating sphere 313.

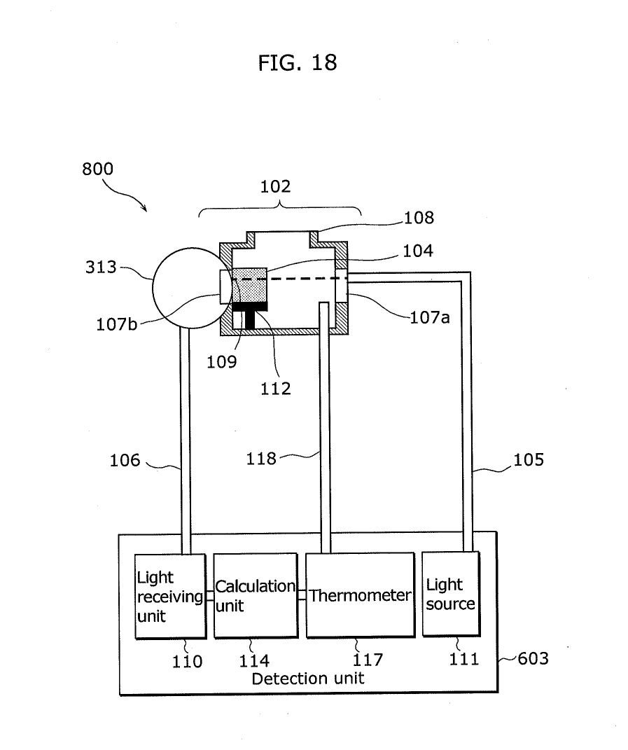

FIG. 18 is a schematic view of the configuration of the vacuum gauge 800 according to the variation. It should be noted that the same reference signs will be used to refer to the same components as in FIG. 15.

As shown in FIG. 18, the vacuum gauge 800 includes the integrating sphere 313 on the outside of the sensor chamber 101 at the position of the measurement window 107b where the receiving optical fiber 106 is provided. In other words, the integrating sphere 313 is disposed between the measurement window 107b and the receiving optical fiber 106. The inner surface of the integrating sphere 313 is applied with a light diffusing material such as a barium sulfate so that light incident on the integrating sphere 313 diffuses.

The measurement light 109 passed through the silica aerogel 104 is diffused by the above-mentioned integrating sphere 313, and received by the receiving optical fiber 106, including scattered light. Use of the integrating sphere 313 reduces loss of light emitted from the silica aerogel 104 to the receiving optical fiber 106, and increases S/N, thereby improving the precision of the vacuum gauge 800.

Variation 3 of Embodiment 4

Next, a variation 3 of Embodiment 4 will be described. A vacuum gauge 900 according to the variation 3 is different from the vacuum gauge 600 according to Embodiment 4 in that the vacuum gauge 900 according to the variation 3 includes one measurement window.

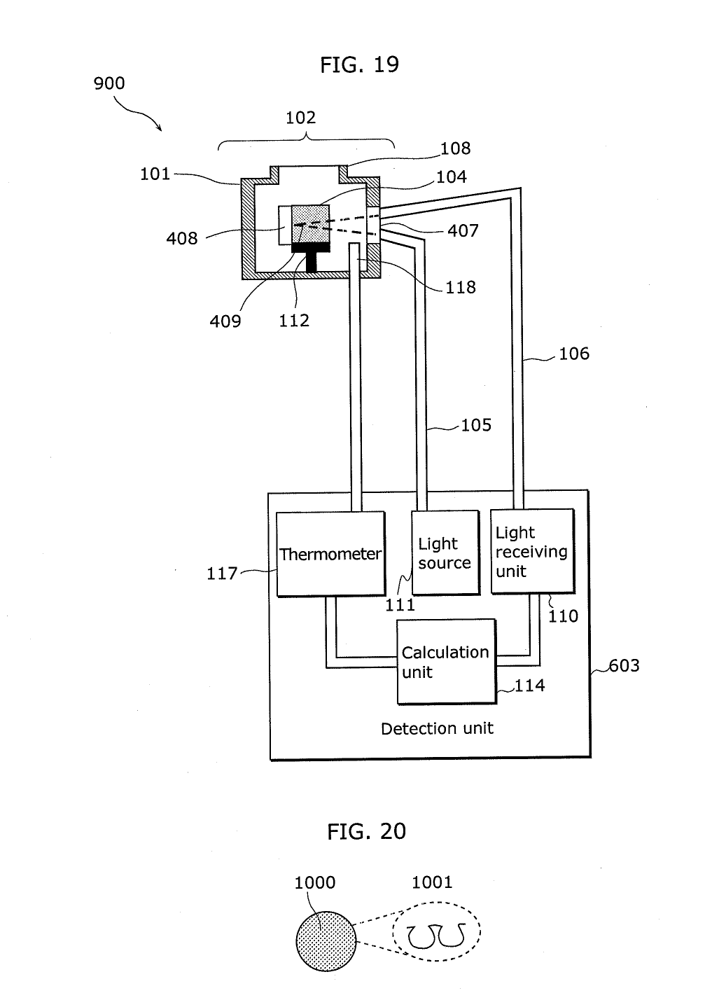

FIG. 19 is a schematic view of the configuration of the vacuum gauge 900 according to the variation. It should be noted that the same reference signs will be used to refer to the same components as in FIG. 15.

As shown in FIG. 19, the vacuum gauge 900 includes a measurement window 407, and further includes the emitting optical fiber 105 and the receiving optical fiber 106 on the outside of the sensor chamber 101 at the position of the measurement window 407. Moreover, a reflector 408 is disposed on an end surface of the silica aerogel 104 opposite to a side where the measurement window 407 is disposed.

Light emitted from the emitting optical fiber 105 is guided to the silica aerogel 104, the transmitted light 409 passed through the silica aerogel 104 is reflected off the reflector 408, and the reflected light is received by the receiving optical fiber 106.

According to the above configuration, the loss of light emitted to the receiving optical fiber 106 reduces and S/N increases, thereby increasing precision of the vacuum gauge 900.

### Embodiment 5

Next, Embodiment 5 according to one aspect disclosed herein will be described. The vacuum gauge according to one aspect disclosed herein will be described also in the present embodiment.

The vacuum gauge according to the present embodiment is different from the vacuum gauge according to Embodiment 4 in that the vacuum gauge according to the present embodiment detects the fluctuation in vacuum degree, using a ratio in light intensity of two light beams having ranges of wavelengths, and temperature. Hereinafter, description will be given, FIG. 15 shown in Embodiment 4, and FIGS. 5 and 9 shown in Embodiment 1.

The vacuum gauge according to the present embodiment detects light having at least a portion of the range of wavelengths of 1850 nm or greater and 1970 nm or less, and light having at least a portion of the range of wavelengths of 600 nm or greater and less than 1850 nm or a portion of the range of wavelengths of 1970 nm or greater and 2000 nm or less to monitor fluctuation in vacuum degree within the process chamber 130, using change in ratio between the light intensity of light having at least a portion of the range of wavelengths of 600 nm or greater and less than 1850 nm or a portion of the range of wavelengths of 1970 nm or greater and 2000 nm or less and the light intensity of light having at least a portion of the range of wavelengths of 1850 nm or greater and 1970 nm or less, and change in temperature, measured by the thermometer 117, within the process chamber 130. In other words, as shown in FIG. 5, the fluctuation in moisture content can be precisely detected and the fluctuation in vacuum degree can be detected, without the effect, if any, of variation in light transmittance of the silica aerogel during measurement by monitoring the change in ratio between: the light intensity of light having at least a portion of the range of wavelengths of 1850 nm or greater and 1970 nm or less where change in spectrum absorption due to adsorption of moisture is large; and the light intensity of light having at least a portion of the range of wavelengths of 600 nm or greater and less than 1850 nm or a portion of the range of wavelengths of 1970 nm or greater and 2000 nm or less where change in spectrum absorption due to adsorption of moisture is small.

As shown in FIG. 9, in the range of wavelengths smaller than 600 nm, the detection is sensitive to degradation of the silica aerogel 104. Thus, at least the wavelength of 600 nm is a preferable range of wavelengths where the change in spectrum absorption due to the adsorption of moisture is small.

For example, a halogen lamp is used for the light source 111 in the vacuum gauge 600 shown in FIG. 15. In this case, one light source may be sufficient. Furthermore, using a diffraction grating for example, the light receiving unit 110 separates, from the received light, light having at least a portion of a range of wavelengths of 1850 nm or greater and 1970 nm or less and light having at least a portion of a range of wavelengths of 600 nm or greater and less than 1850 nm or a portion of the range of wavelengths of 1970 nm or greater and 2000 nm or less, and the light intensity of each of the light having the wavelengths is detected using a photoelectric conversion element such as a photodiode. The calculation unit 114 calculates a ratio between the light intensity of the above-detected light having at least a portion of the range of wavelengths of 600 nm or greater and less than 1850 nm or a portion of the range of wavelengths of 1970 nm or greater and 2000 nm or less and the light intensity of the above-detected light having at least a portion of the range of wavelengths of 1850 nm or greater and 1970 nm or less, and, furthermore, calculates a fluctuation in vacuum degree from (Equation 1), using data, obtained by the thermometer 117, of a temperature within the process chamber 130.

Advantages of calculating the fluctuation in vacuum degree from the ratio of the light intensity of light between two wavelengths is that the fluctuation in moisture content can be precisely detected and the fluctuation in vacuum degree can be calculated, without the effect, if any, of variation in transmittance of the silica aerogel 104 during measurement.

It should be noted that the light source 111 is not limited to the halogen lamp, and may be a white light source such as a Xenon lamp. Alternatively, an LED light source (or a laser light source) may be used which emits light having at least a portion of a range of wavelengths of 600 nm or greater and 2000 nm or less. In this case, two light sources corresponding to respective wavelength are required.

### Embodiment 6

Next, Embodiment 6 according to one aspect disclosed herein will be described. The vacuum gauge according to one aspect disclosed herein will be described also in the present embodiment.

The vacuum gauge according to the present embodiment is different from the vacuum gauge according to Embodiment 4 in that the vacuum gauge according to the present embodiment measures a quantitative vacuum degree while the vacuum gauge according to Embodiment 4 measures a relative vacuum degree (fluctuation in pressure) by initially measuring a. Hereinafter, the vacuum gauge according to the present embodiment will be described.

Quantitative vacuum degree can be obtained by previously creating, using standard gases, correlation data plotting a relationship between a baseline moisture content and the light intensity, and calibrating, using the correlation data, a relative vacuum degree obtained by measurement. Hereinafter, a calibration method for quantification will be described.

First, the measurement of baseline moisture content will be described. Examples of the baseline moisture content include moisture content in the atmosphere, moisture content within a vacuum chamber at a start of degassing, moisture content within a vacuum chamber under nitrogen flow, and moisture content when gas within a chamber is replaced with gas including preset moisture content. For example, correlation data between light intensity and the moisture content is previously created by introducing a gas of known moisture content into a process chamber 130.

In other words, relationship between the variation in light intensity and moisture content per unit volume in the measurement object space in association is stored in a memory 114b included in the calculation unit 114 or an external storage unit (not shown), as the relationship between the change in light intensity and the fluctuation in moisture content in association. In other words, the memory 114b or the external storage unit may store therein the relationship of the change in light intensity with moisture content per unit volume in the measurement object space instead of the fluctuation in moisture content.

The example of the relationship between the change in light intensity and moisture content per unit volume in the measurement object space in association is a table including values of the light intensity and values of moisture content per unit volume in the measurement object space, or a function whereby a value of moisture content per unit volume in the measurement object space is derived using a value of the light intensity as a variable. For example, the relationship between the change in light intensity and moisture content per unit volume in the measurement object space in association may be the table shown in FIG. 14B.

Specifically, standard gases (for example, products of Sumitomo Seika Chemicals Company Limited) are prepared in which known moisture content of 10 ppm, 50 ppm, 100 ppm, 200 ppm, 300 ppm, 400 ppm, 500 ppm are included into nitrogen gas. Then, a ratio is measured which is between the light intensity of light that has at least a portion of the range of wavelengths of 600 nm or greater and less than 1850 nm or a portion of the range of wavelengths of 1970 nm or greater and 2000 nm or less and the light intensity of light that has at least a portion of the range of wavelengths of 1850 nm or greater and 1970 nm or less, when the chamber is filled with each standard gas. A plot of the known moisture content indicated on the horizontal axis and the known ratio of light intensity on the vertical axis is used as correlation data between the light intensity and the moisture content.

By calibrating the known moisture content to the known ratio of the light intensity of the correlation data in the nitrogen gas atmosphere, using, for example, a calibration curve, the moisture content to the light intensity ratio measured in the nitrogen gas atmosphere can be obtained. This allows for quantitative analysis on the density of water molecule. Furthermore, by using the density of water molecule thus obtained and (Equation 1) a vacuum degree in the nitrogen gas atmosphere can be obtained. This allows for quantitative measurement of the vacuum degree.

It should be noted that the above-described correlation data is not limited to correlation data between light intensity and moisture content, and may be correlation data between light intensity, moisture content, and temperature. Moreover, the above-described correlation data may be created using a standard gas of gas species used.

While the calibration method for quantification can be used for the above-described vacuum gauge according to Embodiment 4, more precise quantification is possible when the calibration method used in Embodiment 5 because in the vacuum gauge according to Embodiment 5, a vacuum degree is measured independent of variation in transmittance of the silica aerogel.

In the vacuum gauge according to the present embodiment, the calculation unit 114 refers to the light intensity of the light received from the light receiving unit, and the relationship between the change in light intensity and the fluctuation in moisture content in association to calculate moisture content per unit volume. The calculation unit 114 further calculates the fluctuation in vacuum degree from the relationship between the moisture content and the change in the measured temperature.

As described above, according to the vacuum gauge of the present embodiment, quantified vacuum degree can be obtained by calibrating the measured relative vacuum degree using the correlation data previously created.

Each of the exemplary embodiments described above shows a general or specific example. The numerous other modifications and variations can be devised without departing from the scope of the appended Claims and their equivalents.

For example, while in the embodiments described above, a relative fluctuation in moisture content relative to the baseline is detected, the relative fluctuation in moisture content relative to a reference other than the baseline may be detected.

Moreover, the light used as a light source is not limited to the halogen lamp, and may be a white light source such as a Xenon lamp. Alternatively, an LED light source (or a laser light source) may be used which emits light having at least a portion of a range of wavelengths of 600 nm or greater and 2000 nm or less.

Moreover, while in the embodiments described above, the measurement window is provided to the sensor chamber, the measurement window may not be provided to the sensor chamber by disposing the emitting optical fiber and the receiving optical fiber to extend a location near the silica aerogel within the sensor chamber.

Various modifications to each of the above-described embodiments that may be conceived by those skilled in the art and other embodiments constructed by combining constituent elements in different embodiments are included in the scope of the appended Claims and their equivalents, without departing from the essence of the present disclosure.

For example, apparatuses such as vapor deposition apparatuses and sputter systems, utilizing the above-described moisture content fluctuation detection device or vacuum gauge are also included in the present disclosure. The herein disclosed subject matter is to be considered descriptive and illustrative only, and the appended Claims are of a scope intended to cover and encompass not only the particular embodiment(s) disclosed, but also equivalent structures, methods, and/or uses.

### INDUSTRIAL APPLICABILITY

The moisture content fluctuation detection device, the moisture content fluctuation detection method, the vacuum gauge, and the vacuum degree fluctuation detection method according to one or more exemplary embodiments disclosed herein are applicable as a process control device which detects moisture content fluctuation in a wide bandwidth and vacuum degree fluctuation in a wide bandwidth. The moisture content fluctuation detection device, the moisture content fluctuation detection method, the vacuum gauge, and the vacuum degree fluctuation detection method can be used also in quantitative measurement application of moisture content requiring fast-response, and quantitative measurement application of a vacuum degree.

1. A moisture content fluctuation detection device comprising:
a silica aerogel placed, exposed to a measurement object space; and
a detection unit configured to detect fluctuation in moisture content within the measurement object space, the detection unit including:
a light source for emitting light to the silica aerogel, the light having at least a portion of a range of wavelengths of 1850 nm or greater and 1970 nm or less;
a light receiving unit configured to receive light that has passed through the silica aerogel and has at least a portion of the range of wavelengths of 1850 nm or greater and 1970 nm or less; and
a calculation unit configured to calculate the fluctuation in moisture content within the measurement object space, based on light intensity of the light received by the light receiving unit.

2. The moisture content fluctuation detection device according to claim 1,
wherein the silica aerogel has:
through holes mainly having pore sizes of 10 nm or greater;
a specific surface area of 400 m²/g or greater and 800 m²/g or less; and
a density of 50 kg/m³ or greater and 500 kg/m³ or less.

3. The moisture content fluctuation detection device according to claim 1,
wherein the detection unit further includes a light intensity storage unit configured to store light intensity of received light, and
the calculation unit is configured to refer to a relationship between change in light intensity and fluctuation in moisture content in association and calculate fluctuation in moisture content, based on a difference between the light intensity of the light received by the light receiving unit and the light intensity stored in the light intensity storage unit.

4. The moisture content fluctuation detection device according to claim 1,
wherein the calculation unit is configured to refer to the light intensity of the light received by the light receiving unit and the relationship between the change in light intensity and the fluctuation in moisture content in association and calculate moisture content per unit volume.

5. The moisture content fluctuation detection device according to claim 1,
wherein the light emitted by the light source further has at least a portion of a range of wavelengths of 600 nm or greater and less than 1850 nm or a portion of a range of wavelengths of 1970 nm or greater and 2000 nm or less,
the light receiving unit is further configured to receive light having at least a portion of the range of wavelengths of 600 nm or greater and less than 1850 nm or a portion of the range of wavelengths of 1970 nm or greater and 2000 nm or less, and
the light receiving unit is configured to detect the fluctuation in moisture content within the measurement object space from change in ratio between the light intensity of the light that is received by the light receiving unit and has at least a portion of the range of wavelengths of 600 nm or greater and less than 1850 nm or a portion of the range of wavelengths of 1970 nm or greater and 2000 nm or less and light intensity of the light having at least a portion of the range of wavelengths of 1850 nm or greater and 1970 nm or less.

6. The moisture content fluctuation detection device according to claim 1,
wherein the measurement object space is a space within a variable pressure chamber,
the chamber includes one or more measurement windows through which light is allowed to transmit, the light having at least a portion of the range of wavelengths of 1850 nm or greater and 1970 nm or less,
the light emitted by the light source disposed outside the chamber is emitted through the one or more measurement windows to the silica aerogel placed within the chamber, and
the light emitted to the silica aerogel that has passed through the silica aerogel is received through the one or more measurement windows by the light receiving unit disposed outside the chamber.

7. The moisture content fluctuation detection device according to claim 5,
wherein the measurement object space is a space within a variable pressure chamber,
the chamber includes one or more measurement windows through which light having at least a portion of the range of wavelengths of 1850 nm or greater and 1970 nm or less and light having at least a portion of the range of wavelengths of 600 nm or greater and less than 1850 nm or a portion of the range of wavelengths of 1970 nm or greater and 2000 nm or less are allowed to pass,
the light emitted by the light source disposed outside the chamber is emitted through the one or more measurement windows to the silica aerogel placed within the chamber, and
the light emitted to the silica aerogel that has passed through the silica aerogel is received through the one or more measurement windows by the light receiving unit disposed outside the chamber.

8. The moisture content fluctuation detection device according to claim 1,
wherein the measurement object space is a space within a variable pressure chamber,
the light source and the light receiving unit are disposed outside the chamber,
the light emitted by the light source is emitted via an emitting optical fiber to the silica aerogel placed within the chamber, and
the light emitted to the silica aerogel that has passed through the silica aerogel is received via a receiving optical fiber by the light receiving unit disposed outside the chamber.

9. A moisture content fluctuation detection method comprising:
emitting, by a light source, light to a silica aerogel placed, exposed to a measurement object space, the light having at least a portion of a range of wavelengths of 1850 nm or greater and 1970 nm or less;
receiving, by a light receiving unit, light that has passed through the silica aerogel and has at least a portion of the range of wavelengths of 1850 nm or greater and 1970 nm or less; and
calculating, by a calculation unit, fluctuation in moisture within the measurement object space, based on light intensity of the light received by the light receiving unit.

10. A vacuum gauge comprising:
a silica aerogel placed, exposed to a measurement object space; and
a detection unit configured to detect pressure fluctuation within the measurement object space, the detection unit including:
a light source for emitting light to the silica aerogel, the light having at least a portion of a range of wavelengths of 1850 nm or greater and 1970 nm or less;
a light receiving unit configured to receive light that has passed through the silica aerogel and has at least a portion of the range of wavelengths of 1850 nm or greater and 1970 nm or less;
a thermometer for measuring a temperature within the measurement object space; and
a calculation unit configured to calculate the pressure fluctuation within the measurement object space, based on light intensity of the light received by the light receiving unit and the temperature measured by the thermometer.

11. The vacuum gauge according to claim 10,
wherein the silica aerogel has:
through holes having pore sizes of 10 nm or greater;
a specific surface area of 400 m²/g or greater and 800 m²/g or less; and
a density of 50 kg/m³ or greater and 500 kg/m³ or less.

12. The vacuum gauge according to claim 10,
wherein the detection unit further includes a light intensity storage unit configured to store light intensity of received light, and
the calculation unit is configured to refer to a relationship between change in light intensity and fluctuation in moisture content in association, based on a difference between the light intensity of the light received by the light receiving unit and the light intensity stored in the light intensity storage unit, and calculate pressure fluctuation, based on the fluctuation in moisture content and the temperature measured by the thermometer.

13. The vacuum gauge according to claim 10,
wherein the calculation unit is configured to refer to the light intensity of the light received by the light receiving unit and a relationship between change in light intensity and fluctuation in moisture content in association and calculate moisture content per unit volume.

14. The vacuum gauge according to claim 10,
wherein the light emitted by the light source further has at least a portion of a range of wavelengths of 600 nm or greater and less than 1850 nm or a portion of a range of wavelengths of 1970 nm or greater and 2000 nm or less,
the light receiving unit is further configured to receive light having at least a portion of the range of wavelengths of 600 nm or greater and less than 1850 nm or a portion of the range of wavelengths of 1970 nm or greater and 2000 nm or less, and
the calculation unit is configured to calculate the pressure fluctuation within the measurement object space from change in the temperature measured by the thermometer and change in ratio between light intensity of the light that is received by the light receiving unit and has at least a portion of the range of wavelengths of 600 nm or greater and less than 1850 nm or a portion of the range of wavelengths of 1970 nm or greater and 2000 nm or less and light intensity of the light having at least a portion of the range of wavelengths of 1850 nm or greater and 1970 nm or less.

15. The vacuum gauge according to claim 10,
wherein the measurement object space is a space within a variable pressure chamber,
the chamber includes one or more measurement windows through which light is allowed to transmit, the light having at least a portion of the range of wavelengths of 1850 nm or greater and 1970 nm or less,
the light emitted by the light source disposed outside the chamber is emitted through the one or more measurement windows to the silica aerogel placed within the chamber, and
the light emitted to the silica aerogel that has passed through the silica aerogel is received through the one or more measurement windows by the light receiving unit disposed outside the chamber.

16. The vacuum gauge according to claim 14,
wherein the measurement object space is a space within a variable pressure chamber,
the chamber includes one or more measurement windows through which light having at least a portion of the range of wavelengths of 1850 nm or greater and 1970 nm or less and light having at least a portion of the range of wavelengths of 600 nm or greater and less than 1850 nm or a portion of the range of wavelengths of 1970 nm or greater and 2000 nm or less are allowed to pass,
the light emitted by the light source disposed outside the chamber is emitted through the one or more measurement windows to the silica aerogel placed within the chamber, and
the light emitted to the silica aerogel that has passed through the silica aerogel is received through the one or more measurement windows by the light receiving unit disposed outside the chamber.

17. The vacuum gauge according to claim 10,
wherein the measurement object space is a space within a variable pressure chamber,
the light source and the light receiving unit are disposed outside the chamber,
the light emitted by the light source is emitted via an emitting optical fiber to the silica aerogel placed within the chamber, and
the light emitted to the silica aerogel that has passed through the silica aerogel is received via a receiving optical fiber by the light receiving unit disposed outside the chamber.

18. A vacuum degree fluctuation detection method comprising:
emitting, by a light source, light to a silica aerogel placed, exposed to a measurement object space, the light having at least a portion of a range of wavelengths of 1850 nm or greater and 1970 nm or less;
receiving, by a light receiving unit, light that has passed through the silica aerogel and has at least a portion of the range of wavelengths of 1850 nm or greater and 1970 nm or less;
measuring, by a thermometer, a temperature within the measurement object space; and
calculating, by a calculation unit, pressure fluctuation within the measurement object space, based on light intensity of the light received by the light receiving unit and the temperature measured by the thermometer.
